(19) United States
(12) Patent Application Publication
(10) Pub. No.: US 2007/0047087 A1
(43) Pub. Date: Mar. 1, 2007

(54) Optical film, polarizing plate and image display device

(75) Inventors: Kenichi Fukuda, Minami-Ashigara-shi (JP); Jun Watanabe, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: Fuji Photo Film Co., Ltd., Minami-Ashigara-shi (JP)

(21) Appl. No.: 11/509,720

(22) Filed: Aug. 25, 2006

(30) Foreign Application Priority Data
Aug. 25, 2005 (JP) 2005-244360

(51) Int. Cl. G02B 1/10

(52) U.S. Cl. 359/582

(57) ABSTRACT

An optical film comprises: a transparent plastic film substrate; and a cured layer having a dry thickness of 100 nm or more, formed by coating a curable composition comprising: a low refractive index fine particle having a refractive index of 1.50 or less; and a binder, wherein the low refractive index fine particle is unevenly distributed in the cured layer to a surface portion on the side opposite the transparent plastic film substrate.

### BACKGROUND OF THE INVENTION

1. Field of the Invention

The present invention relates to an optical film formed by unevenly distributing a low refractive index fine particle, a polarizing plate using this optical film, and an image display device. More specifically, the present invention relates to an antireflection hardcoat film formed from a curable composition comprising a surface-modified low refractive index fine particle and a curable resin, a polarizing plate using the same, and an image display device.

2. Description of the Related Art

In various image display devices such as liquid crystal display device (LCD), plasma display panel (PDP), electroluminescence display (ELD) and cathode ray tube display device (CRT), an antireflection film is disposed on the display surface for preventing reduction in the contrast due to reflection of outside light or projection of an image. Accordingly, the antireflection film is required to have high transmittance and high physical strength (e.g., scratch resistance) in addition to high antireflection performance.

The antireflection layer used for the antireflection film has been heretofore provided by forming a single-layer or multilayer thin film. The single-layer film may be obtained by forming a layer (low refractive index layer) having a refractive index lower than that of the substrate to a thickness of, in terms of the optical film thickness, ¼ the wavelength designed and in the case where more reduction of reflectance is necessary, it is known that this may be attained by forming a layer (high refractive index layer) having a refractive index higher than that of the substrate between the substrate and the layer having a low refractive index.

As for such an antireflection film, a multilayer film obtained by laminating transparent metal oxide thin films has been heretofore widely used. The transparent metal oxide thin film is usually formed by a chemical vapor deposition (CVD) process or a physical vapor deposition (PVD) process, particularly by a vacuum vapor deposition process which is a kind of physical vapor deposition process.

Such an antireflection film can be formed also by a wet coating process. This process is suitable for mass production and cost reduction as compared with the vacuum vapor deposition process and therefore, formation of an antireflection film by a roll-to-roll method according to the wet coating process is more widely employed in recent years. Along with expanded demand for an antireflection film formed by the wet coating process, a method of producing an antireflection film at a lower cost is strongly demanded.

In the case of preparing an antireflection film by using a transparent plastic film as the substrate, a constitution of forming a hardcoat layer having a film thickness of about 1 to 10 μm on the substrate to compensate for the physical strength of the plastic film, and then forming an antireflection film, is used.

Therefore, when an antireflection film is prepared by using a wet coating process, the operation of coating, drying and curing a curable composition needs to be repeated at least twice or more, and this extremely reduces the productivity and impedes more cost reduction in the wet coating process.

In addition, this coating system is a method of curing an underlying layer and then stacking an uncured layer thereon and since the underlying layer is already immobilized by curing and the reactive group in the underlying layer is already consumed at the curing, chemical bonding to a layer thereon can be hardly established and interlayer adhesion may not be ensured. The scratch resistance is closely related to the interlayer adhesion, and sufficiently high interlayer adhesion is indispensable for obtaining high scratch resistance. As described above, the requirement for scratch resistance is rapidly increasing in recent years and it is a very important issue to ensure interlayer adhesion and thereby obtain high scratch resistance.

In order to solve such a problem, in view of productivity, JP-A-2003-205264 discloses a production apparatus for a multilayer coating film. As for the enhancement of productivity, certain results are achieved by using such a production apparatus. However, in the case of forming a coating film from a photoradical curing-type resin, nitrogen purging must be performed twice and unless this point is improved, the problem remains in the interlayer adhesion from the aspect of performance, because such a coating system is still a coating method of stacking the layers one by one.

JP-A-2000-53921 and JP-A-2004-359930 disclose a technique of coating a curable composition comprising a fluorine compound with low surface free energy and a high refractive index compound. When this method is used, two layers can be formed by one coating operation and an effect is achieved in view of enhancing the productivity. However, the surface low refractive index layer formed of a fluorine compound has poor cohesive strength and cannot be assured of scratch resistance corresponding to surface chipping resistance which can be evaluated by a steel wool rubbing test or the like. Moreover, the cured film obtained is a thin film having a thickness of 1 μm or less and cannot be assured of surface indentation hardness which can be evaluated by a pencil hardness test or the like, and sufficiently high scratch resistance cannot be obtained.

JP-A-2003-322703 discloses a method of forming a low refractive index layer from one coating solution, where an inorganic fine particle is unevenly distributed to the surface of the low refractive index layer. According to this method, the effect of improving scratch resistance corresponding to surface chipping resistance may be expected by virtue of uneven distribution of the inorganic fine particle to the surface. However, the layer formed by one coating operation is only a low refractive index layer and in the case of providing a plurality of functional layer species by coating, the improvement effect for the enhancement of productivity is not provided.

JP-A-2004-34399 discloses a method of forming two layers at the same time from one coating solution by phase separation. This is a method of precipitating a fine particle by utilizing the difference in specific gravity from a binder resin. In order to obtain an antireflection film having high surface hardness, the inorganic fine particle having a high specific gravity must be caused to rise to the surface rather than the coating solution, and this method cannot be applied.

Japanese Patent 3,218,132, Japanese Patent 3,048,325 and U.S. Pat. No. 6,790,904 disclose a method of forming a cured film having high surface hardness from a coating solution in which a silica fine particle is hydrophobized by chemical modification to cause migration of the particle to the surface. However, these publications are absolutely silent on the application to an antireflection film and the continuous production of the film.

JP-A-2004-333901 discloses a method of coating a composition comprising a fluorine-containing silica particle of 50 to 450 nm, and causing automatic alignment of the particle on the uppermost part of a cured layer to impart antireflection property, where the particle positioned inside the cured layer imparts antiglare property and therefore, an antiglare antireflection film can be formed by one coating operation. However, this method has a problem such that the particle size of 50 to 450 nm is too large to cause migration of the particle to the surface or even if a particle having a particle diameter of 50 to 450 nm is present inside the cured layer, sufficiently high antiglare property cannot be obtained because of its small particle diameter.

JP-A-2005-148376 discloses a method of unevenly distributing a high refractive index fine particle to the surface by using a curable composition comprising a surface-modified high refractive index inorganic fine particle. However, for obtaining an antireflection film by this method, a low refractive index layer needs to be further stacked.

### SUMMARY OF THE INVENTION

An object of the present invention is to provide an optical film assured of high antireflection property, suitability for mass production and excellent scratch resistance. Another object of the present invention is to provide a polarizing plate equipped with the optical film, and an image display device.

As a result of intensive investigations, the present inventors have found that when a curable composition containing a low refractive index fine particle reduced in the surface free energy by chemical surface modification is coated on a transparent plastic film substrate and the low refractive index fine particle is caused to rise to the surface of the coated layer until curing, an antireflection layer and a hardcoat layer can be formed at the same time, and an antireflection hardcoat film assured of high antireflection property, suitability for mass production and excellent scratch resistance can be prepared.

That is, the present inventors have succeeded in attaining the above-described objects by the following constitutions.

1. An optical film comprising: a transparent plastic film substrate; and a cured layer having a dry thickness of 100 nm or more, formed by coating a curable composition comprising: a low refractive index fine particle having a refractive index of 1.50 or less; and a binder resin, wherein the low refractive index fine particle is unevenly distributed in the cured layer to a surface portion on the side opposite the transparent plastic film substrate.

2. The optical film as described in 1 above, wherein a ratio [(B/A)×100] of: an average filling fraction (B) of the low refractive index fine particle in an area in the cured layer, the area being from its upper side surface opposite the transparent plastic film substrate to a deep portion of 100 nm in a film thickness direction; to an average filling fraction (A) of the low refractive index fine particle in the entire cured layer is 150% or more.

3. The optical film as described in 2 above, wherein the ratio [(B/A)×100] is 200% or more.

4. The optical film as described in 2 or 3 above, wherein the ratio [(B/A)×100] is 300% or more.

5. The optical film as described in any one of 1 to 4 above, wherein the cured layer is formed by: coating the curable composition; causing the low refractive index fine particle to rise toward a surface of the cured layer to be formed, until curing; and curing the composition.

6. The optical film as described in any one of 1 to 5 above, wherein a surface of the low refractive index fine particle is chemically modified to decrease its surface free energy.

7. The optical film as described in 6 above, wherein a surface of the low refractive index fine particle is chemically surface-modified to have a surface free energy lower than that on a surface of a cured film formed by curing only the binder resin.

8. The optical film as described in 7 above, wherein the surface free energy of the low refractive index fine particle is 2 dynes/cm or more lower than that on the surface of a cured film formed by curing only the binder resin.

9. The optical film as described in 7 above, wherein the surface free energy of the low refractive index fine particle is 5 dynes/cm or more lower than that on the surface of a cured film formed by curing only the binder resin.

10. The optical film as described in any one of 1 to 9 above, wherein an organic compound containing a fluoroalkyl group and/or a silicone group is fixed to the surface of the low refractive index fine particle.

11. The optical film as described in 10 above, wherein the surface of the low refractive index fine particle is surface-modified with an organosilane compound represented by the following formula (III):
(Rf-L¹)ₙ-Si(R¹¹)ₙ₋₄ Formula (III):
wherein Rf represents a linear, branched or cyclic fluorine-containing alkyl group having a carbon number of 1 to 20 or a fluorine-containing aromatic group having a carbon number of 6 to 14, L¹ represents a divalent linking group having a carbon number of 10 or less, n represents an integer of 1 to 3, and R¹¹ represents a hydroxyl group or a hydrolyzable group.

12. The optical film as described in 10 or 11 above, wherein the surface of the low refractive index fine particle is surface-modified with an organosilane compound represented by the following formula (IV):
CₙF₂ₙ₊₁—(CH₂)ₘ—Si(R)₃ Formula (IV):
wherein n represents an integer of 1 to 10, m represents an integer of 1 to 5, and R represents an alkoxy group having a carbon number of 1 to 5 or a halogen atom.

13. The optical film as described in any one of 10 to 12 above, wherein the surface of the low refractive index fine particle is surface-modified with an organosilane compound represented by the following formula (V):
(CH₃)₃Si—(O—Si(CH₃)₂)ₙ₁—(CH₂)ₙ₂—Si(R¹²)₃ Formula (V):
wherein n1 represents an integer of 1 to 50, n2 represents an integer of 0 to 17, and R¹² represents an alkoxy group having a carbon number of 1 to 5 or a halogen atom.

14. The optical film as described in any one of 1 to 13 above, wherein the curable composition further comprises 5 mass % or more of an organic solvent having a solubility parameter (SP value) of 9.5 or more.

15. The optical film as described in 14 above, wherein the curable composition further comprises 15 mass % or more of an organic solvent having a solubility parameter (SP value) of 9.5 or more.

16. The optical film as described in 14 or 15 above, wherein the curable composition further comprises 5 mass % or more of an organic solvent having a solubility parameter (SP value) of 10.0 or more.

17. The optical film as described in 16 above, wherein the curable composition further comprises 15 mass % or more of an organic solvent having a solubility parameter (SP value) of 10.0 or more.

18. The optical film as described in any one of 1 to 17 above, wherein the refractive index of the low refractive index fine particle is 1.46 or less.

19. The optical film as described in any one of 1 to 17 above, wherein the refractive index of the low refractive index fine particle is 1.43 or less.

20. The optical film as described in any one of 1 to 19 above, wherein the low refractive index fine particle is any one of silicon dioxide (silica), magnesium fluoride, calcium fluoride and barium fluoride.

21. The optical film as described in any one of 1 to 20 above, wherein the low refractive index fine particle is a silica fine particle.

22. The optical film as described in any one of 1 to 21 above, wherein the low refractive index fine particle is a hollow silica fine particle.

23. The optical film as described in any one of 1 to 22 above, wherein the average particle diameter of the low refractive index fine particle is 120 nm or less.

24. The optical film as described in any one of 1 to 22 above, wherein the average particle diameter of the low refractive index fine particle is 100 nm or less.

25. The optical film as described in any one of 1 to 22 above, wherein the average particle diameter of the low refractive index fine particle is 80 nm or less.

26. The optical film as described in any one of 1 to 25 above, wherein when the cured layer surface is rubbed with a #0000 steel wool in 10 reciprocations while applying a load of 1.96N/cm², a rubbing mark is not observed with an eye.

27. The optical film as described in any one of 1 to 26 above, wherein the average film thickness of the cured layer is from 1.0 to 40 μm.

28. The optical film as described in any one of 1 to 26 above, wherein the average film thickness of the cured layer is from 2.0 to 30 μm.

29. The optical film as described in any one of 1 to 26 above, wherein the average film thickness of the cured layer is from 3.0 to 25 μm.

30. A polarizing plate comprising: a polarizing film; and two protective films located on both sides of the polarizing film, wherein at least one of the two protective film is the optical film described in any one of 1 to 29 above.

31. A polarizing plate comprising: a polarizing film; and two protective films located on both sides of the polarizing film, wherein one of the two protective films is the optical film described in any one of 1 to 29, and the other one of the two protective films is an optical compensation film having optical anisotropy.

32. An image display device having comprising, on an image display surface thereof, the optical film described in any one of 1 to 29 above or the polarizing plate described in any one of 30 to 31 above.

33. The image display device as described in 32 above, wherein the image display device is a transmissive, reflective or transflective liquid crystal display device in any one mode of TN, STN, IPS, VA and OCB.

### BRIEF DESCRIPTION OF THE DRAWINGS

FIG. 1 is a schematic view for explaining how to obtain the average particle filling fraction of low refractive index fine particles on the embodiment of the present invention.

### DETAILED DESCRIPTION OF THE INVENTION

The preparation method and the like of the optical film of the present invention are described below.

In the present invention, when a numerical value denotes a physical property value, a characteristic value or the like, the term “from (numerical value 1) to (numerical value 2)” means “(numerical value 1) or more and (numerical value 2) or less”.

The present invention relates to an optical film comprising a transparent plastic film substrate having thereon a cured layer formed of a transparent resin, wherein the low refractive index fine particle in the cured layer has a concentration gradient in the thickness direction, with the concentration being high in the surface opposite the transparent plastic film substrate, and the low refractive index is unevenly distributed particularly to the surface part.

In the present invention, a low refractive index fine particle is unevenly distributed to the surface of a cured layer, whereby the surface side in the cured layer forms an apparent low refractive index layer (hereinafter referred to as an “apparent low refractive index layer”). As a result, the optical film of the present invention can be assured of low reflectance by virtue of the antireflection effect of the apparent low refractive index layer. Also, since the apparent low refractive index layer can be formed at once from a single cured layer, the production efficiency is high and the problem of interlayer adhesion failure does not arise. This effect is great particularly when a radical polymerization system resin is used for the binder, because this system has a problem of curing inhibition by oxygen. Furthermore, when a high-hardness inorganic fine particle such as silica fine particle is used as the low refractive index fine particle, surface scratch resistance can be imparted at the same time.

<Layer Structure>

In the optical film of the present invention, following known layer structures may be used.

Representative examples of the layer structure include:

a: transparent plastic film substrate/(antireflection hardcoat layer),

b: transparent plastic film substrate/hardcoat layer/(high refractive index layer/low refractive index layer), and

c: transparent plastic film substrate/hardcoat layer/medium refractive index layer/(high refractive index layer/low refractive index layer).

The layers shown in the parenthesis above are the cured layer of the present invention.

Examples of the layer which may be provided between the transparent plastic film substrate and a layer closer to the surface side include an antistatic layer (when, for example, reduction in the surface resistivity from the display side is required and attachment of dusts to the surface or the like becomes a problem), a hardcoat layer (when hardness is insufficient only by the above-described constitutions), a moisture-proofing layer, an adhesion-improving layer, and an interference fringe-preventing layer (when a refractive index difference of 0.03 or more is present between the substrate and the light-diffusing layer).

<Cured Layer>

[Method for Reducing Reflectance]

In the present invention, antireflection property can be imparted to the cured layer by reducing the surface free energy of the low refractive index fine particle and unevenly distributing the low refractive index fine particle to the upper part of the cured layer. The method of unevenly distributing the low refractive index layer to the surface, thereby controlling the distribution in the thickness direction and imparting antireflection property, which is employed in the present invention, includes the following two methods:

(1) a method of introducing a refractive index inclined structure into the cured layer, and

(2) a method of introducing an apparent low refractive index layer into the cured layer surface.

(1) Method of Introducing a Refractive Index Inclined Structure into the Cured Layer

As is known, when the cured layer formed on a transparent substrate is designed such that the refractive index of the area in contact with the substrate is nearly equal to the refractive index of the substrate and the refractive index is continuously decreased toward the outermost surface, the reflectance on the surface can be decreased. According to such an antireflection method, the reflectance can be decreased over a wide range of the visible light region.

In the present invention, the surface free energy of the low refractive index fine particle and the polarity of a solvent in a curable composition for the formation of a cured layer are controlled to cause the low refractive index fine particle to gradually migrate onto the cured layer, whereby a refractive index inclined structure can be introduced into the cured layer.

In order to introduce such a refractive index inclined structure, the film thickness of the cured layer is 100 nm or more, preferably 1 μm or more and more preferably 2 μm or more. Examples of the application of such a structure include an antireflection hardcoat layer where a hardcoat property is imparted by selecting the binder to give high hardness to the cured layer.

(2) Method of Introducing an Apparent Low Refractive Index Layer into the Cured Layer Surface

As is widely known, when a low refractive index layer having an optical film thickness of λ/4 is provided on a cured layer such as hardcoat layer, an antireflection film can be formed. In the present invention, the low refractive index fine particle is concentrated in the upper part of the cured layer, whereby an apparent low refractive index layer can be formed. The optical film thickness can be adjusted to λ/4 by controlling the amount of the low refractive index fine particle added.

In the present invention, the surface free energy of the low refractive index fine particle and the polarity of a solvent in a curable composition for the formation of a cured layer are controlled to cause excessive migration of the low refractive index fine particle to the cured layer surface and form a clear boundary between the low refractive index fine particle migrated portion and the bulk region, and the film thickness of the migrated portion is adjusted by the amount of the low refractive index fine particle added, whereby an apparent low refractive index layer can be introduced.

The application of such introduction of an apparent low refractive index layer includes a method where in an antireflection hardcoat film having a two-layer structure of hardcoat layer/low refractive index layer, a hardcoat layer and a low refractive index layer are simultaneously formed by setting the film thickness of the cured layer to 100 nm or more, preferably 1 μm or more and more preferably 2 μm or more and selecting the binder to give high hardness to the cured layer.

Other examples include a method where in an antireflection layer having a two- or three-layer structure described in the <Layer Structure> above, a high refractive index layer/a low refractive index layer are simultaneously formed by setting the film thickness of the cured layer to 1 μm or less and forming the cured layer from a high refractive index binder. Here, a binder having uniformly dispersed therein a high refractive index fine particle such as titanium oxide may be used in place of the high refractive index binder. In this case, the high refractive index fine particle may be uniformly dispersed in the cured film, but it is preferred that the concentration thereof increases toward the substrate.

[Distribution of Low Refractive Index Fine Particle in Layer]

In the optical film of the present invention, the cured layer is formed by coating a composition containing a low refractive index fine particle and a binder on a substrate, and the ratio [(B/A)×100] of an average particle filling fraction (B) of the low refractive index fine particle in the cured layer within the range of a film thickness of 100 nm on its upper side opposite the substrate (in other words, an average filling fraction (B) of the low refractive index fine particle in an region in the cured layer, the region being from its upper side surface opposite the transparent plastic film substrate to a deep portion of 100 nm in a film thickness direction) to an average particle filling fraction (A) of the low refractive index fine particle in the entire cured layer is preferably 150% or more. The average particle filling fraction (A) as used in the present invention is determined by the following method.

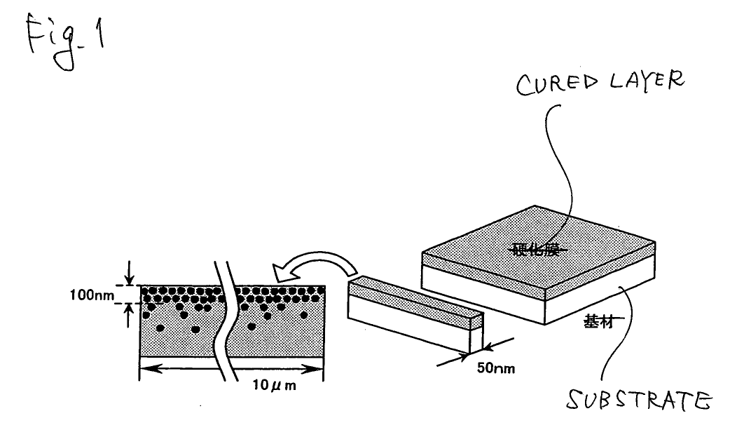

As shown in FIG. 1, an optical film is sliced at arbitrary five sites of the optical film to obtain thin leaves having a thickness of 50 nm, these thin leaves were observed by a transmission electron microscope and photographed at a magnification of 50,000, the number of particles on each of the thin leaves is counted over the length of 10 μM along the cured layer surface, and the number of particles per unit area in the cured layer is calculated on the cross-sectional photograph and used as an average particle filling fraction (A). The average particle filling factor (B) in the cured layer within the range of a film thickness of 100 nm on the upper side opposite the substrate is calculated in the same manner as the average particle filling factor (A). Also, for example, when the particle is partially contained in the cured layer within the range of a film thickness of 100 nm on the upper side (in other words, the particle is partially contained in the above-mentioned region), the number of particles is calculated by multiplying the ratio of the area of the particle contained in that region on the cross-sectional photograph. That is, when 70% of the area of a certain particle is contained within the range of a film thickness of 100 nm on the upper side, this is counted as 0.7 particle. Furthermore, when the particle is observed in the overlapped state on the cross-sectional photograph of the 50 nm-thick sliced specimen, the overlapped portion is also counted. In this case, the distribution of particles in the layer has no directional property in the plane direction of the layer, and the average particle filling factor can be determined based on the number of particles in a specific cross-section selected as a sliced specimen.

In the present invention, the [(B/A)×100] is, in view of antireflection, more preferably 150% or more, still more preferably 200% or more, and most preferably 300% or more.

Hereinafter, components used for the invention will be explained in detail.

<Low Refractive Index Fine Particle>

The low refractive index fine particle usable in the present invention is preferably a low refractive index inorganic fine particle, and preferred examples thereof include silicon dioxide (silica) and a fluorine-containing particle (e.g., magnesium fluoride, aluminum fluoride, calcium fluoride, lithium fluoride, sodium fluoride, barium fluoride). Among these, more preferred are silicon dioxide (silica), magnesium fluoride, calcium fluoride and barium fluoride, and still more preferred are silicon dioxide (silica).

The refractive index of the low refractive index fine particle is 1.50 or less, preferably 1.46 or less, more preferably 1.43 or less. As the refractive index is lower, a higher antireflection effect is obtained.

The mass average particle diameter of primary particles of the low refractive index fine particle is preferably from 1 to 120 nm, more preferably from 1 to 100 nm, still more preferably from 1 to 80 nm.

The mass average particle diameter of primary particles can be determined from an electron micrograph.

The low refractive index fine particle is preferably dispersed in a finer state in a curable composition for the formation of a cured layer.

The low refractive index fine particle preferably has a pebble-like, spherical, cubic, spindle-like, staple-like, ring-like, hollow or amorphous shape, more preferably a spherical, amorphous or hollow shape, still more preferably a hollow shape.

The low refractive index fine particle may be either crystalline or non-crystalline.

As for the commercial product available on the market as a liquid dispersion of silicon oxide fine particle (e.g., silica particle), examples of the colloidal silica include Methanol Silica Sol, MA-ST-MS, EPA-ST, IPA-ST-MS, IPA-ST-L, IPA-ST-ZL, IPA-ST-UP, EG-ST, NPC-ST-30, MEK-ST, MEK-ST-L, MIK-ST, NBA-ST, XBA-ST, DMAC-ST, ST-UP, ST-OUP, ST-20, ST-40, ST-C, ST-N, ST-O, ST-50 and ST-OL produced by Nissan Chemical Industries, Ltd.; and examples of the hollow silica include CS60-IPA produced by Catalysts & Chemicals Industries Co., Ltd. As for the powder silica, examples thereof include Aerosil 130, Aerosil 300, Aerosil 380, Aerosil TT600 and Aerosil OX50 produced by Nippon Aerosil Co., Ltd.; Sildex H31, H32, H51, H52, H121 and H122 produced by Asahi Glass Co., Ltd.; E220A and E220 produced by Nippon Silica Kogyo K.K.; SYLYSIA 470 produced by Fuji Silysia Chemical Ltd.; and SG Flake produced by Nippon Sheet Glass Co., Ltd.

In the case where the low refractive index fine particle is a silicon dioxide (silica) fine particle, use of a hollow silicon dioxide fine particle is preferred.

The refractive index of the hollow silica fine particle is preferably from 1.17 to 1.40, more preferably from 1.17 to 1.35, and most preferably from 1.17 to 1.30. The refractive index as used herein indicates a refractive index of the particle as a whole and does not indicate a refractive index of only silica as an outer shell forming the hollow silica particle. At this time, assuming that the radius of the cavity inside the particle is a and the radius of the outer shell of the particle is b, the porosity x represented by the following mathematical formula (VIII) is preferably from 10 to 60%, more preferably from 20 to 60%, and most preferably from 30 to 60%.
x=(4πa³/3)/(4πb³/3)×100 (Mathematical Formula VIII)

If the hollow silica particle is made to have a lower refractive index and a higher porosity, the thickness of the outer shell becomes small and the strength of the particle decreases. Therefore, in view of scratch resistance, a particle having a refractive index as low as less than 1.17 cannot be used.

Here, the refractive index of the hollow silica particle was measured by an Abbe refractometer (manufactured by ATAGO K.K.).

The production method of the hollow silica is described, for example, in JP-A-2001-233611 and JP-A-2002-79616.

The coated amount of the hollow silica is preferably from 1 to 100 mg/m², more preferably from 5 to 80 mg/m², still more preferably from 10 to 60 mg/m². If the coated amount is too small, the effect of reducing the refractive index or improving the scratch resistance decreases, whereas if it is excessively large, fine irregularities are generated on the cured layer surface and the appearance (e.g., real black) or the integrated reflectance may deteriorate.

The average particle diameter of the hollow silica is preferably from 30 to 120 nm, more preferably from 35 to 80 nm, still more preferably from 40 to 60 nm.

If the particle diameter of the silica fine particle is too small, the proportion of the cavity moiety decreases and reduction in the refractive index may not be attained, whereas if it is excessively large, fine irregularities are generated on the cured layer surface and the appearance (e.g., real black) or the integrated reflectance may deteriorate. The silica fine particle may be either crystalline or amorphous, and a monodisperse particle is preferred. The shape is most preferably spherical but even if amorphous, there arises no problem.

Here, the average particle diameter of the hollow silica can be determined from an electron micrograph.

In the present invention, a silica particle having no cavity may be used in combination with the hollow silica. In this case, the silica having no cavity is also preferably subjected to the same surface modification as that of the hollow silica. The particle size of the silica having no cavity is preferably from 30 to 120 nm, more preferably from 35 to 80 nm, and most preferably from 40 to 60 nm.

Also, at least one kind of a silica fine particle having an average particle diameter corresponding to less than 25% of the thickness of the apparent low refractive index layer (this particle is referred to as a “small-particle-size silica fine particle”) is preferably used in combination with a silica fine particle having the above-described particle diameter (this particle is referred to as a “large-particle-size silica fine particle”).

The small-particle-size silica fine particle can be present in a gap between large-particle-size silica fine particles and therefore, can contribute as a holding agent for the large-particle-size silica fine particle.

The average particle diameter of the small-particle-size silica fine particle is preferably from 1 to 20 nm, more preferably from 5 to 15 nm, still more preferably from 10 to 15 nm. Use of such a silica fine particle is preferred in view of the raw material cost and the holding agent effect.

[Surface Chemical Modification of Low Refractive Index Fine Particle]

The surface chemical modification of the low refractive index fine particle in the cured layer is described below.

In the present invention, the surface of the low refractive index inorganic fine particle is preferably reduced in the surface free energy by chemical modification, and the surface free energy is preferably reduced to be lower than the surface free energy on the surface of a cured film formed by curing only the binder resin.

The refractive index and the mass average particle diameter of the low refractive index fine particle whose surface is subjected to chemical modification are preferably within the ranges set forth above, respectively.

The surface free energy of a cured film formed by curing only the binder resin can be estimated from contact angles of the cured film surface with water and methylene iodide by using a known method. The cured film formed by curing only the binder resin means a cured film formed by removing a compound unevenly distributed to the surface from at least the composition for the formation of a cured layer. The compound which may be unevenly distributed to the surface includes a surfactant, a silicone oil and a fine particle reduced in the surface free energy by chemical modification. This cured film is preferably formed by removing all dispersed materials such as fine particle from the composition for the formation of a cured layer.

The difference between the surface free energy measured as above of the low refractive index fine particle and the surface free energy of a cured film formed by curing only the binder resin is preferably 2 dynes/cm or more, more preferably 5 dynes/cm or more.

The surface free energy of the low refractive index inorganic fine particle may also be estimated from contact angles with water and methylene iodide on the surface of a coated film formed by coating an inorganic fine particle liquid dispersion and removing the solvent therefrom or on the surface of a tablet formed from an inorganic fine particle powder before dispersion in a solvent (a liquid dispersion from which the solvent is removed may be used in place of the powder) by means of a tablet-forming device.

The method for estimating the surface free energy from a contact angle is not particularly limited, but examples thereof include the method described in JP-A-2002-148792, paragraphs [0044] to [0047].

In order to reduce the surface free energy on the surface of the low refractive index fine particle, an organic compound containing a hydrophobic group is preferably fixed to the surface of the low refractive index inorganic fine particle. In the case where the low refractive index inorganic fine particle is a silica particle, an organosilane represented by the following formula (I) having a substituent capable of reacting with the silanol group on the surface may also be used.

For this purpose, it is preferred that the inorganic fine particle is chemically surface-modified with a hydrolysate of an organosilane represented by the following formula (I) and/or a partial condensate thereof and at the chemical modification of the inorganic oxide fine particle surface, either one or both of an acid catalyst and a metal chelating compound described later is used.

[Organosilane Compound]

The organosilane compound for use in the present invention is described in detail.
(R¹⁰)ₘ—Si(X)₄₋ₘ Formula (I):

In formula (I), R¹⁰ represents a substituted or unsubstituted alkyl group or a substituted or unsubstituted aryl group.

Examples of the alkyl group include a methyl group, an ethyl group, a propyl group, an isopropyl group, a hexyl group, a tert-butyl group, a sec-butyl group, a hexyl group, a decyl group and a hexadecyl group.

The alkyl group is preferably an alkyl group having a carbon number of 1 to 30, more preferably from 1 to 16, still more preferably from 1 to 6.

Examples of the aryl group include a phenyl group and a naphthyl group, with a phenyl group being preferred.

X represents a hydroxyl group or a hydrolyzable group. Examples of the hydrolyzable group include an alkoxy group (preferably an alkoxy group having a carbon number of 1 to 5, such as methoxy group and ethoxy group), a halogen atom (e.g., Cl, Br, I) and a R²COO group (wherein R² is preferably a hydrogen atom or an alkyl group having a carbon number of 1 to 5; e.g., CH₃COO, C₂H₅COO). Among these, an alkoxy group is preferred, and a methoxy group and an ethoxy group are more preferred.

m represents an integer of 1 to 3. When a plurality of R¹⁰'s or X's are present, the plurality of R¹⁰'s or X's may be the same or different. m is preferably 1 or 2, more preferably

The substituent contained in R¹⁰ is not particularly limited, but examples thereof include a halogen atom (e.g., fluorine, chlorine, bromine), a hydroxyl group, a mercapto group, a carboxyl group, an epoxy group, an alkyl group (e.g., methyl, ethyl, i-propyl, propyl, tert-butyl), an aryl group (e.g., phenyl, naphthyl), an aromatic heterocyclic group (e.g., furyl, pyrazolyl, pyridyl), an alkoxy group (e.g., methoxy, ethoxy, i-propoxy, hexyloxy), an aryloxy group (e.g., phenoxy), an alkylthio group (e.g., methylthio, ethylthio), an arylthio group (e.g., phenylthio), an alkenyl group (e.g., vinyl, 1-propenyl), an acyloxy group (e.g., acetoxy, acryloyloxy, methacryloyloxy), an alkoxycarbonyl group (e.g., methoxycarbonyl, ethoxy-carbonyl), an aryloxycarbonyl group (e.g., phenoxycarbonyl), a carbamoyl group (e.g., carbamoyl, N-methylcarbamoyl, N,N-dimethylcarbamoyl, N-methyl-N-octylcarbamoyl) and an acylamino group (e.g., acetylamino, benzoylamino, acrylamino, methacrylamino). These substituents each may be further substituted. Incidentally, in the present invention, even when the hydrogen atom is substituted by a single atom, for the sake of convenience, this is referred to as a substituent.

When a plurality of R¹⁰'s are present, at least one is preferably a substituted alkyl group or a substituted aryl group. In particular, when the binder of the cured layer is formed of a compound having a vinyl polymerizable group, the substituted alkyl group or the substituted aryl group preferably further has a vinyl polymerizable group. In this case, the compound represented by formula (I) may be expressed as an organosilane compound having a vinyl polymerizable substituent, represented by the following formula (II).

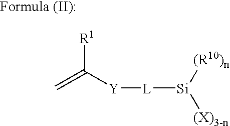

In formula (II), R¹ represents a hydrogen atom, a methyl group, a methoxy group, an alkoxycarbonyl group, a cyano group, a fluorine atom or a chlorine atom. Examples of the alkoxycarbonyl group include a methoxycarbonyl group and an ethoxycarbonyl group. R¹ is preferably a hydrogen atom, a methyl group, a methoxy group, a methoxycarbonyl group, a cyano group, a fluorine atom or a chlorine atom, more preferably a hydrogen atom, a methyl group, a methoxycarbonyl group, a fluorine atom or a chlorine atom, still more preferably a hydrogen atom or a methyl group.

Y represents a single bond, an ester group, an amido group, an ether group or a urea group. Y is preferably a single bond, an ester group or an amido group, more preferably a single bond or an ester group, still more preferably an ester group.

L represents a divalent linking chain. L is specifically a substituted or unsubstituted alkylene group, a substituted or unsubstituted arylene group, a substituted or unsubstituted alkylene group having in the inside thereof a linking group (e.g., ether, ester, amido), or a substituted or unsubstituted arylene group having in the inside thereof a linking group, preferably a substituted or unsubstituted alkylene group having a carbon number of 2 to 10, a substituted or unsubstituted arylene group having a carbon number of 6 to 20, or an alkylene group having in the inside thereof a linking group and having a carbon number of 3 to 10, more preferably an unsubstituted alkylene group, an unsubstituted arylene group or an alkylene group having in the inside thereof an ether or ester linking group, still more preferably an unsubstituted alkylene group or an alkylene group having in the inside thereof an ether or ester linking group. Examples of the substituent include a halogen, a hydroxyl group, a mercapto group, a carboxyl group, an epoxy group, an alkyl group and an aryl group. These substituents each may be further substituted.

n represents 0 or 1. When a plurality of X's are present, the plurality of X's may be the same or different. n is preferably 0.

R¹⁰ has the same meaning as R¹⁰ in formula (I) and is preferably a substituted or unsubstituted alkyl group or an unsubstituted aryl group, more preferably an unsubstituted alkyl group or an unsubstituted aryl group.

X has the same meaning as X in formula (I) and is preferably a halogen, a hydroxyl group or an unsubstituted alkoxy group, more preferably chlorine, a hydroxyl group or an unsubstituted alkoxy group having a carbon number of 1 to 6, still more preferably a hydroxyl group or an alkoxy having a carbon number of 1 to 3, and yet still more preferably a methoxy group.

In order to reduce the surface free energy on the low refractive index fine particle surface, an organosilane compound containing a fluoroalkyl group and/or a silicone group may also be preferably used.

Furthermore, it is also possible to previously treat the silica particle surface with a silane coupling agent having a functional group and then fix a compound having a fluoroalkyl group and/or a silicon group. In this case, a silane coupling agent having any one member of an amino group, an epoxy group and a vinyl group is preferably used in view of reactivity.

Specific examples of these compounds include Compounds M-1 to M-38 and M-47 set forth later, but the present invention is not limited thereto.

The fluoroalkyl group is preferably a perfluoroalkyl group, and specific examples of the perfluoroalkyl group, which are not particularly limited, include a perfluoromethyl group, a perfluoropropyl group, a perfluorobutyl group, a perfluorohexyl group, a perfluorooctyl group, a perfluorodecyl group, a perfluorododecyl group and a perfluorotetradecyl group. One of these perfluoroalkyl groups or an appropriate combination of two or more thereof may be contained. Incidentally, in the perfluoroalkyl group, a part of the fluorine atom may be substituted by other atoms such as chlorine atom within the range of not impairing the effect of the present invention.

Specific examples of the silicone group, which are not particularly limited, include dimethylsilicone group, a diphenylsilicone group, a methylphenylsilicone group, a diethylsilicone group and a methylethylsilicone group. One of these silicone groups or an appropriate combination of two or more thereof may be contained. In particular, when the silicone group is at least one member selected from a dimethylsilicone group and a diphenylsilicone group, introduction of an organic compound to be fixed to the low refractive index fine particle surface is facilitated and this is preferred.

The organosilane compound for use in the present invention is preferably an organosilane compound represented by the following formula (III), because the surface energy of the inorganic fine particle can be reduced.
(Rf-L¹)ₙ-Si(R¹¹)ₙ₋₄ Formula (III):

In the formula above, Rf represents a linear, branched or cyclic fluorine-containing alkyl group having a carbon number of 1 to 20 or a fluorine-containing aromatic group having a carbon number of 6 to 14. Rf is preferably a linear, branched or cyclic fluoroalkyl group having a carbon number of 3 to 10, more preferably a linear fluoroalkyl group having a carbon number of 4 to 8. L¹ represents a divalent linking group having a carbon number of 10 or less, preferably an alkylene group having a carbon number of 1 to 10, more preferably an alkylene group having a carbon number of 1 to 5. The alkylene group is a linear, branched, substituted or unsubstituted alkylene group which may have a linking group (e.g., ether, ester, amide) in the inside. The alkylene group may have a substituent and in this case, preferred examples of the substituent include a halogen atom, a hydroxyl group, a mercapto group, a carboxyl group, an epoxy group, an alkyl group and an aryl group. R¹¹ represents a hydroxyl group or a hydrolyzable group, preferably an alkoxy group having a carbon number of 1 to 5 or a halogen atom, more preferably a methoxy group, an ethoxy group or a chlorine atom. n represents an integer of 1 to 3.

Among the fluorine-containing silane coupling agents represented by formula (III), preferred is a fluorine-containing silane coupling agent represented by the following formula (IV):
CₙF₂ₙ₊₁—(CH₂)ₘ—Si(R)₃ Formula (IV):
wherein n represents an integer of 1 to 10, m represents an integer of 1 to 5, and R represents an alkoxy group having a carbon number of 1 to 5 or a halogen atom. n is preferably an integer of 4 to 10, m is preferably an integer of 1 to 3, and R is preferably a methoxy group, an ethoxy group or a chlorine atom.

Specific Examples of these fluorine-containing silane coupling agents include Compounds M-56 to M-87 set forth later, but the present invention is not limited thereto.

In the present invention, the silicone group-containing organosilane compound capable of reducing the surface energy of the silica fine particle is preferably an organosilane compound represented by the following formula (V):
(CH₃)₃Si—(O—Si(CH₃)₂)ₙ₁—(CH₂)ₙ₂—Si(R¹²)₃ Formula (V):
wherein n1 represents an integer of 1 to 50, n2 represents an integer of 0 to 17, and R¹² represents an alkoxy group having a carbon number of 1 to 5 or a halogen atom. R¹² is preferably a methoxy group, an ethoxy group or a chlorine atom.

In addition to the above-described silane coupling agent for reducing the surface free energy of the low refractive index fine particle, a silane coupling agent having the same species of a functional group as the binder forming the cured layer is preferably used in combination, because the film strength can be increased.

In this case, a silane coupling agent having any one member of an amino group, an epoxy group and a vinyl group is preferably used in view or reactivity.

Specific examples of such a compound include Compounds M-1 to M-38 and M-47 set forth later, but the present invention is not limited thereto.

Two or more kinds of the compounds represented by formula (I) may be used in combination.

Specific examples of the compound represented by formula (I) are set forth below, but the present invention is not limited thereto.

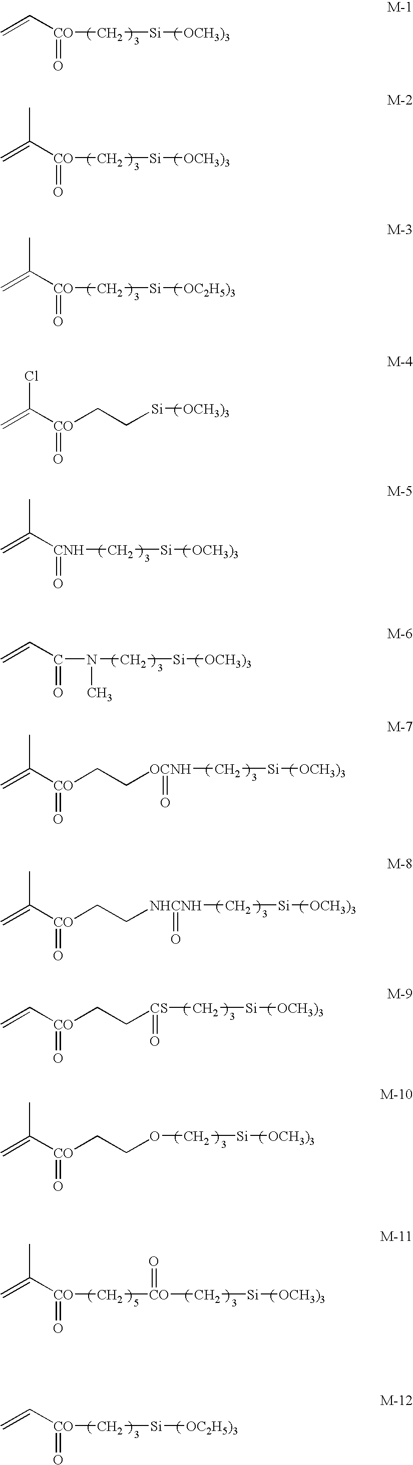

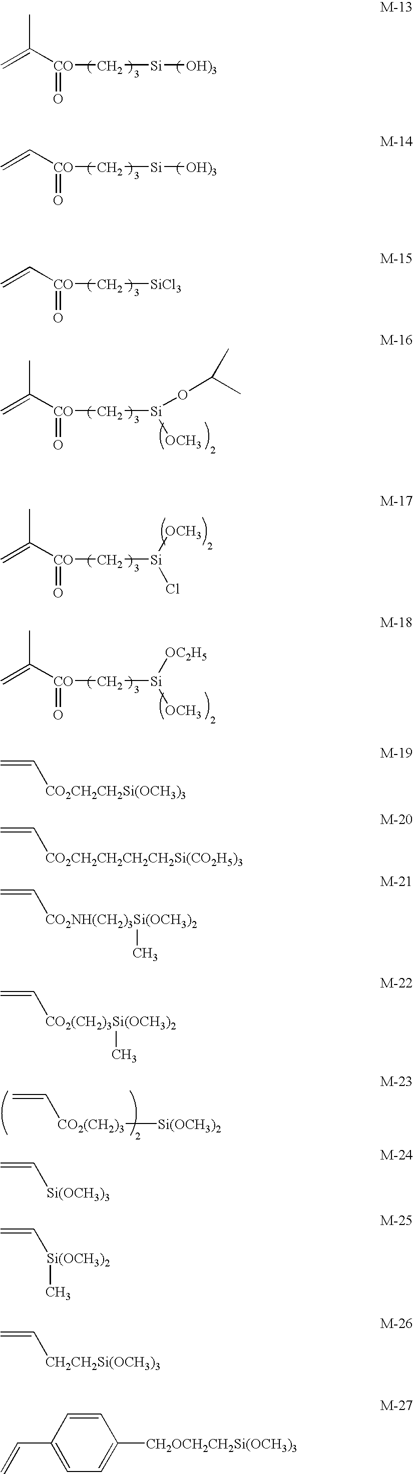

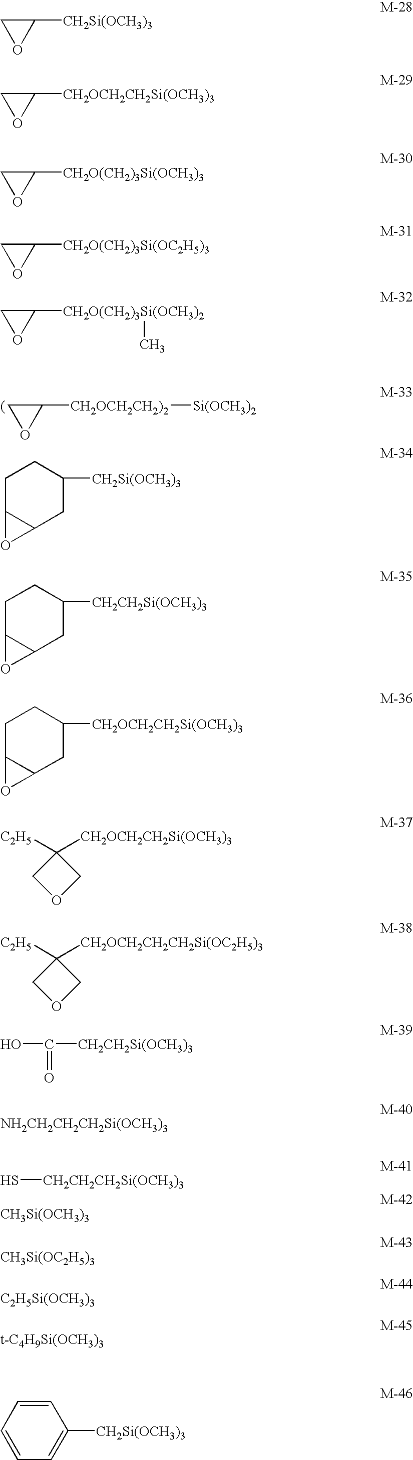

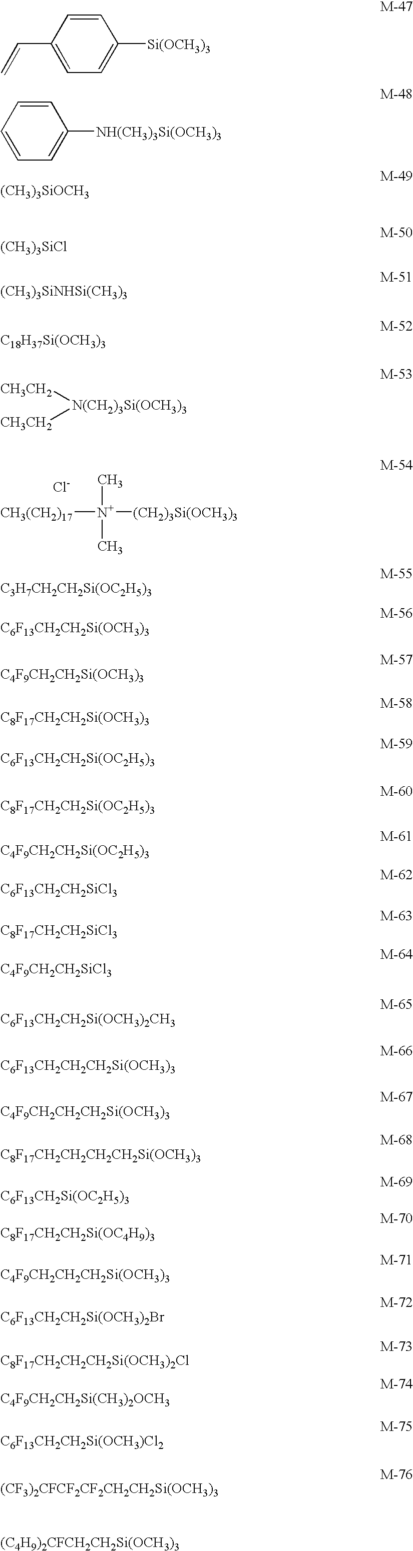

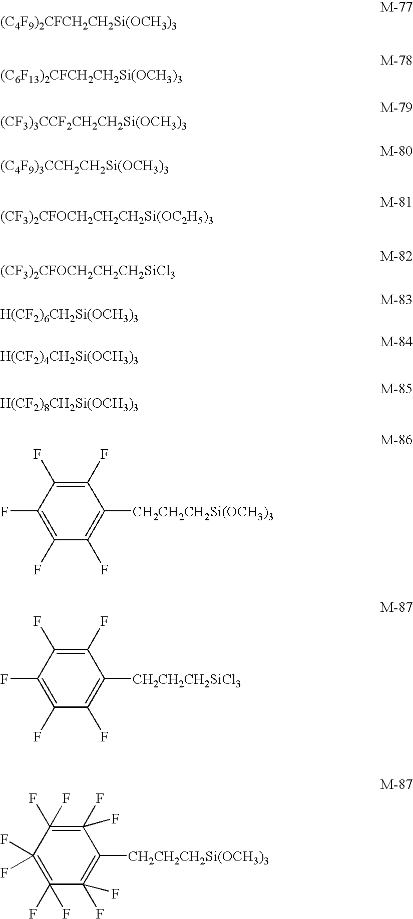

Among these specific examples, (M-1), (M-2), (M-56) and (M-57) are preferred. In the present invention, the amount used of the organosilane compound represented by formula (I) is not particularly limited but is preferably from 1 to 300 mass %, more preferably from 3 to 100 mass %, most preferably from 5 to 50 mass %, per a silica fine particle. Also, the amount used is preferably from 1 to 300 mol %, more preferably from 5 to 300 mol %, most preferably from 10 to 200 mol %, per the normality concentration (formol) based on the hydroxyl group on the silica fine particle surface.

When the amount of the organosilane compound used is within the above-described range, a satisfactory effect of stabilizing the liquid dispersion can be obtained and the film strength at the formation of a coating film increases. A plurality of organosilane compound species are preferably used in combination, and the plurality of compound species may be added at the same time or may be reacted by adding these at different times. Also, when a plurality of compound species are previously formed into a partial condensate and the partial condensate is added, the control of reaction is facilitated and this is preferred.

In the present invention, a hydrolysate of the above-described organosilane and/or a partial condensate thereof is caused to act on the silica fine particle surface, whereby the surface free energy of the silica fine particle is reduced.

The hydrolysis and condensation reaction is preferably performed by adding water in an amount of 0.3 to 2.0 mol, preferably from 0.5 to 1.0 mol, per mol of the hydrolyzable group (X) and stirring it at 15 to 100° C. in the presence of an acid catalyst or metal chelate compound for use in the present invention.

[Solvent for Surface Chemical Modification]

The surface chemical modification of silica with a hydrolysate of organosilane and/or a condensation reaction product may be performed without a solvent or in a solvent. In the case of using a solvent, the concentration of the hydrolysate of organosilane and/or the partial condensate thereof may be appropriately selected. As for the solvent, an organic solvent is preferably used for uniformly mixing the components, and suitable examples thereof include alcohols, aromatic hydrocarbons, ethers, ketones and esters.

The solvent is preferably a solvent capable of dissolving the hydrolysate of organosilane and/or the condensation reaction product and a catalyst. In view of the process, the organic solvent is preferably used as a coating solution or a part of a coating solution. Also, a solvent which does not impair the solubility or dispersibility when mixed with other materials such as fluorine-containing polymer is preferred.

Examples of the alcohols include a monohydric alcohol and a dihydric alcohol. The monohydric alcohol is preferably a saturated aliphatic alcohol having a carbon number of 1 to 8. Specific examples of these alcohols include methanol, ethanol, n-propyl alcohol, i-propyl alcohol, n-butyl alcohol, sec-butyl alcohol, tert-butyl alcohol, ethylene glycol, diethylene glycol, triethylene glycol, ethylene glycol monobutyl ether and ethylene glycol monoethyl ether acetate.

Specific examples of the aromatic hydrocarbons include benzene, toluene and xylene. Specific examples of the ethers include tetrahydrofuran and dioxane. Specific examples of the ketones include acetone, methyl ethyl ketone, methyl isobutyl ketone and diisobutyl ketone. Specific examples of the esters include ethyl acetate, propyl acetate, butyl acetate and propylene carbonate.

One of these organic solvents may be used alone or two or more thereof may be used in combination. The concentration of the organosilane compound based on the solvent in the treatment is not particularly limited but is usually from 0.1 to 70 mass %, preferably from 1 to 50 mass %.

In the present invention, after the inorganic oxide fine particle is dispersed with an alcohol-based solvent, it is preferred to perform the treatment of improving the dispersibility and subsequently displace the dispersion solvent by an aromatic hydrocarbon solvent or a ketone-based solvent. From the standpoint of increasing the affinity for a binder used in combination at the coating or enhancing the stability of the dispersion itself, displacement by a ketone-based solvent is preferred.

[Catalyst for Surface Chemical Modification]

The treatment of improving the dispersibility with a hydrolysate of organosilane and/or a condensation reaction product is preferably performed in the presence of a catalyst. Examples of the catalyst include inorganic acids such as hydrochloric acid, sulfuric acid and nitric acid; organic acids such as oxalic acid, acetic acid, formic acid, methanesulfonic acid and toluenesulfonic acid; inorganic bases such as sodium hydroxide, potassium hydroxide and ammonia; organic bases such as triethylamine and pyridine; and metal alkoxides such as triisopropoxyaluminum and tetrabutoxyzirconium. In view of production stability or storage stability of the inorganic fine particle solution, an acid catalyst (inorganic acids, organic acids) and/or a metal chelate compound is used in the present invention. As for the inorganic acid, a hydrochloric acid and a sulfuric acid are preferred, and as for the organic acid, an organic acid having an acid dissociation constant (pKa value (25° C.)) of 4.5 or less in water is preferred. In particular, a hydrochloric acid, a sulfuric acid and an organic acid having an acid dissociation constant of 3.0 or less in water are preferred, a hydrochloric acid, a sulfuric acid and an organic acid having an acid dissociation constant of 2.5 or less in water are more preferred, and an organic acid having an acid dissociation constant of 2.5 or less in water is still more preferred. Among these, a methanesulfonic acid, an oxalic acid, a phthalic acid and a malonic acid are more preferred, and an oxalic acid is still more preferred.

In the case where the hydrolyzable group of the organosilane is an alkoxy group and the acid catalyst is an organic acid, the carboxyl group or sulfo group of the organic acid supplies a proton and therefore, the amount of water added can be reduced. The amount of water added is from 0 to 2 mol, preferably from 0 to 1.5 mol, more preferably from 0 to 1 mol, still more preferably from 0 to 0.5 mol, per mol of the alkoxide group of the organosilane. In the case of using an alcohol as the solvent, substantially no addition of water is also preferred.

In the case where the acid catalyst is an inorganic acid, the amount of the acid catalyst used is from 0.01 to 10 mol %, preferably from 0.1 to 5 mol %, based on the hydrolyzable group. In the case where the acid catalyst is an organic acid, the optimum amount of the catalyst used varies depending on the amount of water added, but when water is added, the amount of the catalyst used is from 0.01 to 10 mol %, preferably from 0.1 to 5 mol %, based on the hydrolyzable group, and when water is not substantially added, the amount of the catalyst used is from 1 to 500 mol %, preferably from 10 to 200 mol %, more preferably from 20 to 200 mol %, still more preferably from 50 to 150 mol %, yet still more preferably from 50 to 120 mol %, based on the hydrolyzable group.

The treatment is performed with stirring at 15 to 100° C., but the conditions are preferably adjusted depending on the reactivity of organosilane.

[Metal Chelate Compound]

As for the metal chelate compound, any metal chelate compound may be suitably used without particular limitation as long as an alcohol represented by the following formula (2-1) and/or a compound represented by the following formula (2-2) is present as a ligand and the center metal is a metal selected from Zr, Ti and Al. Within this scope, two or more kinds of metal chelate compounds may be used in combination.
R²¹OH Formula (2-1):
R²²COCH₂COR²³ Formula (2-2):
(wherein R²¹ and R²², which may be the same or different, each represents an alkyl group having a carbon number of 1 to 10, and R²³ represents an alkyl group having a carbon number of 1 to 10 or an alkoxy group having a carbon number of 1 to 10).

The metal chelate compound suitably used in the present invention is preferably selected from the group consisting of compounds represented by the following formulae:
Zr(OR²¹)_{c1}(22COCHCOR²³)_{c2},
Ti(OR²¹)_{d1}(R²²COCHCOR²³)_{d2}, and
Al(OR²¹)ₑ₁(R²²COCHCOR²³)e₂.

Such a compound has a function of accelerating the condensation reaction of the organosilane compound.

In the metal chelate compounds, R²¹ and R²², which may be the same or different, each represents an alkyl group having a carbon number of 1 to 10, such as ethyl group, n-propyl group, i-propyl group, n-butyl group, sec-butyl group, tert-butyl group, n-pentyl group and phenyl group, and R²³ represents an alkyl group having a carbon number of 1 to 10 similarly to the above or an alkoxy group having a carbon number of 1 to 10, such as methoxy group, ethoxy group, n-propoxy group, i-propoxy group, n-butoxy group, sec-butoxy group and tert-butoxy group. Also, in the metal chelate compounds, c1, c2, d1, d2, e1 and e2 each represents an integer determined to give a tetradentate or hexadentate coordination.

Specific examples of these metal chelate compounds include a zirconium chelate compound such as tri-n-butoxyethylacetoacetate zirconium, di-n-butoxy-bis(ethyl-acetoacetate) zirconium, n-butoxy-tris(ethylacetoacetate)zirconium, tetrakis(n-propylacetoacetate) zirconium, tetrakis(acetylacetoacetate)zirconium and tetrakis-(ethylacetoacetate) zirconium; a titanium chelate compound such as diisopropoxy-bis(ethylacetoacetate) titanium, diisopropoxy-bis(acetylacetonate) titanium, diisopropoxy-bis(acetylacetate) titanium and diisopropoxy-bis(acetylacetone) titanium; and an aluminum chelate compound such as diisopropoxyethylacetoacetate aluminum, diisopropoxyacetylacetonate aluminum, isopropoxy-bis(ethylacetoacetate) aluminum, isopropoxy-bis(acetylacetonate) aluminum, tris(ethylacetoacetate) aluminum, tris(acetyl-acetonate) aluminum and monoacetylacetonato-bis(ethylacetoacetate) aluminum.

Among these metal chelate compounds, preferred are tri-n-butoxyethylacetoacetate zirconium, diisopropoxy-bis(acetylacetonate) titanium, diisopropoxyethylacetoacetate aluminum and tris(ethylacetoacetate) aluminum. One of these metal chelate compounds may be used alone, or two or more species thereof may be used as a mixture. Also, a partial hydrolysate of such a metal chelate compound can be used.

In view of the condensation reaction rate and the film strength when a coating film is formed, the metal chelate compound is preferably used at a proportion of 0.01 to 50 mass %, more preferably from 0.1 to 50 mass %, still more preferably from 0.5 to 10 mass %, based on the organosilane compound.

[Additive for Stabilizing Curable Composition]

In addition to those organosilane compound, acid catalyst and chelate compound, the curable composition for layer formation used in the present invention preferably contains a β-diketone compound and/or a β-ketoester compound, represented by the following formula (3). Such a compound acts as a stability enhancer of the curable composition for layer formation used in the present invention.
R³¹COCH₂COR³² Formula (3):

More specifically, the compound represented by formula (3) is considered to coordinate to a metal atom in the metal chelate compound (zirconium, titanium and/or aluminum compound) and thereby act to suppress the action of the metal chelate compound of accelerating the condensation reaction of the organosilane with the metal chelate component and enhance the storage stability of the composition obtained. In the compound represented by formula (3), R³¹ and R³² are the same as R²² and R²³ constituting the metal chelate compound.

Specific examples of the β-diketone compound and the β-ketoester compound, represented by formula (3), include acetylacetone, methyl acetoacetate, ethyl acetoacetate, n-propyl acetoacetate, i-propyl acetoacetate, n-butyl acetoacetate, sec-butyl acetoacetate, tert-butyl acetoacetate, 2,4-hexadione, 2,4-heptadione, 3,5-heptadione, 2,4-octadione, 2,4-nonadione and 5-methylhexadione. Among these, ethyl acetoacetate and acetylacetone are preferred, and acetylacetone is more preferred.

One of these β-diketone compounds and β-ketoester compounds may be used alone, or two or more species thereof may be used as a mixture.

In the present invention, the β-diketone compound and the β-ketoester compound each is preferably used in an amount of 2 mol or more, more preferably from 3 to 20 mol, per mol of the metal chelate compound. When the amount added is 2 mol or more, the composition obtained is free from fear of poor storage stability and this is preferred.

[Hardcoat Layer]

As for the function of the cured layer of the present invention, there is a hardcoat layer having an antireflection property and scratch resistance. In this case, the hardcoat layer is preferably a cured layer having scratch resistance such that when the cured layer surface is rubbed with a #0000 steel wool in 10 reciprocations while applying a load of 1.96N/cm², a rubbing mark is not observed with an eye.

In the case where the cured layer of the present invention functions as the hard coat layer, the thickness thereof is preferably 1.0 to 40 μm, more preferably 2.0 to 30 μM and particularly preferably 3.0 to 25 μm. The indentation surface hardness, which is evaluated by the pencil hardness test, can be secured by thickening the thickness of the hard coat layer. On the other hand, curling and degradation on fragility can be prevented by keeping the upper limit of the thickness thereof as above-mentioned range.

The components other than the low refractive index fine particle, which can be incorporated into the hardcoat layer of the present invention, are described below.

The hardcoat layer of the present invention is formed of a curable composition, and the curable composition comprises the above-described low refractive index fine particle and a binder for imparting hardcoat property and, if desired, further contains a matting particle for imparting antiglare property or internal scattering property, and an inorganic fine particle for elevating the refractive index, preventing the crosslinking shrinkage or increasing the strength.

<Curable Resin>

The curable resin is preferably a binder polymer having a saturated hydrocarbon chain or a polyether chain as the main chain, more preferably a binder polymer having a saturated hydrocarbon chain as the main chain. Also, the binder polymer preferably has a crosslinked structure.

The binder polymer having a saturated hydrocarbon chain as the main chain is preferably a polymer of an ethylenically unsaturated monomer. The binder polymer having a saturated hydrocarbon chain as the main chain and having a crosslinked structure is preferably a (co)polymer of a monomer having two or more ethylenically unsaturated groups.

In order to more elevate the refractive index of the binder polymer, for example, a high refractive index monomer obtained by incorporating an aromatic ring or at least one atom selected from a halogen atom (except for fluorine), a sulfur atom, a phosphorus atom and a nitrogen atom into the structure of the above-described monomer, or a monomer having a fluorene skeleton within the molecule may also be selected.

Examples of the monomer having two or more ethylenically unsaturated groups include an ester of a polyhydric alcohol and a (meth)acrylic acid [e.g., ethylene glycol di(meth)acrylate, butanediol di(meth)acrylate, hexanediol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, polyester polyacrylate], an ethylene oxide-modified or caprolactone-modified product of such an ester, a vinylbenzene and a derivative thereof [e.g., 1,4-divinylbenzene, 2-acryloylethyl4-vinylbenzoate, 1,4-divinylcyclohexanone], a vinylsulfone (e.g., divinylsulfone), an acrylamide (e.g., methylenebisacrylamide), and a methacrylamide. Two or more species of these monomers may be used in combination.

Specific examples of the high refractive index monomer include (meth)acrylates having a fluorene skeleton, bis(4-methacryloylthiophenyl) sulfide, vinylnaphthalene, vinylphenyl sulfide and 4-methacryloxyphenyl-4′-methoxyphenyl thioether. Two or more species of these monomers may also be used in combination.

The polymerization of such an ethylenically unsaturated group-containing monomer can be performed by ionizing radiation irradiation or heating in the presence of a photoradical initiator or a thermal radical initiator.

Accordingly, the hardcoat layer can be formed by preparing a coating solution containing a monomer for the curable resin formation, such as ethylenically unsaturated monomer described above, a photoradical or thermal radical initiator and the low refractive index fine particle and, if desired, further containing an inorganic filler except for the low refractive index fine particle, which is described later, a matting particle and a leveling agent, applying the coating solution onto a transparent substrate, and curing the coating film through a polymerization reaction by the effect of ionizing radiation or heat.

Examples of the photoradical polymerization initiator include acetophenones, benzoins, benzophenones, phosphine oxides, ketals, anthraquinones, thioxanthones, azo compounds, peroxides, 2,3-dialkyldione compounds, disulfide compounds, fluoroamine compounds, aromatic sulfoniums, lophine dimers, onium salts, borate salts, active esters, active halogens, inorganic complexes and coumarins.

Examples of the acetophenones include 2,2-dimethoxyacetophenone, 2,2-diethoxyacetophenone, p-dimethylacetophenone, 1-hydroxydimethyl phenyl ketone, 1-hydroxy-dimethyl-p-isopropyl phenyl ketone, 1-hydroxycyclohexyl phenyl ketone, 2-methyl-4-methylthio-2-morpholinopropiophenone, 2-benzyl-2-dimethylamino-1-(4-morpholinophenyl)butanone, 4-phenoxydichloroacetophenone and 4-tert-butyl-dichloroacetophenone.

Examples of the benzoins include benzoin, benzoin methyl ether, benzoin ethyl ether, benzoin isopropyl ether, benzyl dimethyl ketal, benzoin benzenesulfonic acid ester, benzoin toluenesulfonic acid ester, benzoin methyl ether, benzoin ethyl ether and benzoin isopropyl ether.

Examples of the benzophenones include benzophenone, hydroxybenzophenone, 4-benzoyl-4′-methyldiphenyl sulfide, 2,4-dichlorobenzophenone, 4,4-dichlorobenzophenone, p-chlorobenzophenone, 4,4′-dimethylaminobenzophenone (Michler's ketone) and 3,3′,4,4′-tetra(tert-butylperoxycarbonyl)benzophenone.

Examples of the phosphine oxides include 2,4,6-trimethylbenzoyldiphenylphosphine oxide.

Examples of the active esters include 1,2-octanedione, 1-[4-(phenylthio)-2-(O-benzoyloxime)], sulfonic acid esters and cyclic active ester compounds.

Examples of the onium salts include an aromatic diazonium salt, an aromatic iodonium salt and an aromatic sulfonium salt.

Examples of the borate salts include ion complexes with a cationic pigment.

As for the active halogens, an s-triazine or oxathiazole compound is known, and examples thereof include 2-(p-methoxyphenyl)-4,6-bis(trichloromethyl)-s-triazine, 2-(p-methoxyphenyl)-4,6-bis(trichloromethyl)-s-triazine, 2-(p-styrylphenyl)-4,6-bis(trichloromethyl)-s-triazine, 2-(3-Br-4-di(ethyl acetate)amino)phenyl)-4,6-bis(trichloro-methyl)-s-triazine and 2-trihalomethyl-5-(p-methoxyphenyl)-1,3,4-oxadiazole.

Examples of the inorganic complexes include bis(η⁵-2,4-cyclopentadien-1-yl)-bis(2,6-difluoro-3-(1H-pyrrol-1-yl)-phenyl)titanium.

Examples of the coumarins include 3-ketocoumarin.

One of these initiators may be used alone, or some members thereof may be used as a mixture.

Also, various examples are described in Saishin UV Koka Gijutsu (Latest UV Curing Technology), page 159, Gijutsu Joho Kyokai (1991), and these are useful in the present invention.

Preferred examples of the commercially available photoradical polymerization initiator of photo-cleavage type include Irgacure (e.g., 651, 184, 819, 907, 1870 (a 7/3 mixed initiator of CGI-403/Irg 184), 500, 369, 1173, 2959, 4265, 4263) and OXE01 produced by Ciba Specialty Chemicals; KAYACURE (e.g., DETX-S, BP-100, BDMK, CTX, BMS, 2-EAQ, ABQ, CPTX, EPD, ITX QTX, BTC, MCA) produced by Nippon Kayaku Co., Ltd.; and Esacure (e.g., KIP100F, KB1, EB3, BP, X33, KT046, KT37, KIP150, TZT) produced by Sartomer Company, Inc.

The photopolymerization initiator is preferably used in an amount of 0.1 to 15 parts by mass, more preferably from 1 to 10 parts by mass, per 100 parts by mass of the polyfunctional monomer.

In addition to the photopolymerization initiator, a photosensitizer may be used. Specific examples of the photosensitizer include n-butylamine, triethylamine, tri-n-butylphosphine, Michler's ketone and thioxanthone.

Furthermore, one or more auxiliary such as azide compound, thiourea compound and mercapto compound may be used in combination.

Examples of the commercially available photosensitizer include KAYACURE (e.g., DMBI, EPA) produced by Nippon Kayaku Co., Ltd.

As for the thermal radical initiator, an organic or inorganic peroxide, an organic azo or diazo compound, or the like may be used.

Specific examples of the organic peroxide include benzoyl peroxide, halogen benzoyl peroxide, lauroyl peroxide, acetyl peroxide, dibutyl peroxide, cumene hydroperoxide and butyl hydroperoxide; specific examples of the inorganic peroxide include hydrogen peroxide, ammonium persulfate and potassium persulfate; specific examples of the azo compound include 2,2′-azobis(isobutyronitrile), 2,2′-azobis(propionitrile) and 1,1′-azobis(cyclohexanecarbonitrile); and specific examples of the diazo compound include diazoaminobenzene and p-nitrobenzenediazonium.

The polymer having a polyether as the main chain is preferably a ring-opened polymer of a polyfunctional epoxy compound. The ring-opening polymerization of the polyfunctional epoxy compound may be performed by ionizing radiation irradiation or heating in the presence of a photoacid generator or a thermal acid generator.

Accordingly, the hardcoat layer can be formed by preparing a coating solution containing a polyfunctional epoxy compound, a photoacid generator or thermal acid generator and the low refractive index fine particle and, if desired, further containing a matting particle, a leveling agent and an inorganic filler except for the low refractive index fine particle, which are described later, applying the coating solution on a transparent substrate, and curing the coating film through a polymerization reaction by the effect of ionizing radiation or heat.

A crosslinked structure may be introduced into the binder polymer by using a crosslinking functional group-containing monomer in place of or in addition to the monomer having two or more ethylenically unsaturated groups, thereby introducing a crosslinking functional group into the polymer, and causing a reaction of the crosslinking functional group.

Examples of the crosslinking functional group include an isocyanate group, an epoxy group, an aziridine group, an oxazoline group, an aldehyde group, a carbonyl group, a hydrazine group, a carboxyl group, a methylol group and an active methylene group. In addition, a vinylsulfonic acid, an acid anhydride, a cyanoacrylate derivative, a melamine, an etherified methylol, an ester, a urethane, and a metal alkoxide (e.g., tetramethoxysilane) may also be utilized as the monomer for introducing a crosslinked structure. A functional group which exhibits crosslinking property as a result of decomposition reaction, such as block isocyanate group, may also be used. That is, in the present invention, the crosslinking functional group may be a functional group which exhibits reactivity not directly but as a result of decomposition.

The binder polymer having such a crosslinking functional group can form a crosslinked structure under heating after coating.

[Matting Particle]

For the purpose of imparting antiglare property and internal scattering property, the hardcoat layer contains, if desired, a matting particle. The average particle diameter of the aforementioned matting agent is preferably from 1.0 to 15 μm, more preferably from 2.0 to 10 μm, and particularly preferably from 3.0 to 8.0 μm. The angular distribution for light scattering can be suppressed within an appropriate range by controlling the average particle diameter to 1.0 μm or larger, thus preventing displayed characters from blurring. On the other hand, by controlling the average particle diameter to 15 μm or less, the layer thickness of the hardcoat layer can be suppressed within an appropriate range, thus preventing curling. Specific preferred examples of the matting particle include an inorganic compound particle such as silica particle and TiO₂ particle; and a resin particle such as crosslinked acryl particle, crosslinked acryl-styrene particle, crosslinked styrene particle, melamine resin particle and benzoguanamine resin particle. Among these, a crosslinked acryl particle, a crosslinked acryl-styrene particle and a crosslinked styrene particle are more preferred. The shape of the matting particle may be either true spherical or amorphous. Also, two or more different kinds of matting particles may be used in combination. The matting particle is preferably contained in the antiglare hardcoat layer such that the amount of the matting particle in the antiglare hardcoat layer formed becomes from 10 to 1,000 mg/m², more preferably from 30 to 100 mg/m². In a more preferred embodiment, a crosslinked styrene particle is used as the matting particle, and a crosslinked styrene particle having a particle diameter larger than a half of the thickness of the hardcoat layer occupies from 40 to 100% in all crosslinked styrene particles. Here, the particle size distribution of the matting particle is measured by a Coulter counter method, and the measured distribution is converted into the particle number distribution.

[Inorganic Oxide Fine Particle]

The inorganic oxide fine particle except for the low refractive index fine particle, which can be used in the present invention, is described below.

In view of colorlessness of the cured film obtained from the curable composition, the inorganic oxide particle is preferably an oxide particle of at least one element selected from the group consisting of silicon, aluminum, zirconium, titanium, zinc, germanium, indium, tin, antimony and cerium.

This inorganic fine particle is introduced for the purpose of achieving elevated refractive index, prevented crosslinking shrinkage and increased strength of the hardcoat layer, and it is preferred that such an inorganic fine particle is uniformly dispersed in the thickness direction of the cured film. In addition, such an embodiment that the high refractive index fine particles are distributed in such a manner that their concentration becomes higher towards the substrate in the thickness direction for the cured layer, opposite to the distribution of the low refractive index fine particles as described above is preferable.

Examples of the inorganic oxide fine particle include particles of silica, alumina, zirconia, titanium oxide, zinc oxide, germanium oxide, indium oxide, tin oxide, indium-tin oxide (ITO), antimony oxide and cerium oxide. Among these, particles of silica, alumina, zirconia and antimony oxide are preferred in the light of high hardness. One of these inorganic oxide fine particles may be used alone or two or more species thereof may be used in combination. Furthermore, the inorganic oxide fine particle is preferably used as an organic solvent dispersion. In the case of use as an organic solvent dispersion, the dispersion medium is preferably an organic solvent in view of compatibility with other components and dispersibility. Examples of such an organic solvent include alcohols such as methanol, ethanol, isopropanol, butanol and octanol; ketones such as acetone, methyl ethyl ketone, methyl isobutyl ketone and cyclohexanone; esters such as ethyl acetate, butyl acetate, ethyl lactate, γ-butyrolactone, propylene glycol monomethyl ether acetate and propylene glycol monoethyl ether acetate; ethers such as ethylene glycol monomethyl ether and diethylene glycol monobutyl ether; aromatic hydrocarbons such as benzene, toluene and xylene; and amides such as dimethylformamide, dimethylacetamide and N-methylpyrrolidone. Among these, preferred are methanol, isopropanol, butanol, methyl ethyl ketone, methyl isobutyl ketone, ethyl acetate, butyl acetate, toluene and xylene.

The number average particle diameter of the oxide particle is preferably from 1 to 2,000 nm, more preferably from 3 to 200 nm, still more preferably from 5 to 100 nm. If the number average particle diameter exceeds 2.000 nm, a cured product reduced in the transparency or a coating film having a deteriorated surface state tends to result. In order to improve the dispersibility of particles, various surfactants or amines may also be added.

Examples of the commercial product available on the market as a liquid dispersion of silicon oxide fine particle (e.g., silica particle) include, as a colloidal silica, Methanol Silica Sol, MA-ST-MS, IPA-ST, IPA-ST-MS, IPA-ST-L, IPA-ST-ZL, IPA-ST-UP, EG-ST, NPC-ST-30, MEK-ST, MEK-ST-L, MIBK-ST, NBA-ST, XBA-ST, DMAC-ST, ST-UP, ST-OUP, ST-20, ST-40, ST-C, ST-N, ST-O, ST-50 and ST-OL produced by Nissan Chemical Industries, Ltd.; as a hollow silica, CS60-IPA produced by Catalysts & Chemicals Industries Co., Ltd.; and, as a powder silica, Aerosil 130, Aerosil 300, Aerosil 380, Aerosil TT600 and Aerosil OX50 produced by Nippon Aerosil Co., Ltd., Sildex H31, H32, H51, H52, H121 and H122 produced by Asahi Glass Co., Ltd., E220A and E220 produced by Nippon Silica Kogyo K.K., SYLYSIA 470 produced by Fuji Silysia Chemical Ltd., and SG Flake produced by Nippon Sheet Glass Co., Ltd.

Other examples include, as a water dispersion of alumina, Alumina Sol-100, Alumina Sol-200 and Alumina Sol-520 produced by Nissan Chemical Industries, Ltd.; as an isopropanol dispersion of alumina, AS-150I produced by Sumitomo Osaka Cement Co., Ltd.; as a toluene dispersion of alumina, AS-150T produced by Sumitomo Osaka Cement Co., Ltd.; as a toluene dispersion of zirconia, HXU-110JC produced by Sumitomo Osaka Cement Co., Ltd.; as a water dispersion of zinc antimonate powder, Celnax produced by Nissan Chemical Industries, Ltd.; as a powder and a solvent dispersion of alumina, titanium oxide, tin oxide, indium oxide, zinc oxide and the like, NanoTek produced by C.I. Kasei Co., Ltd.; as a water dispersion sol of antimony-doped tin oxide, SN-100D produced by Ishihara Sangyo Kaisha, Ltd.; as an ITO powder, products of Mitsubishi Materials Corp.; and as a water dispersion of cerium oxide, Needral produced by Taki Chemical Co., Ltd.

The shape of the oxide particle is spherical, hollow, porous, rod-like, plate-like, fibrous or amorphous, preferably spherical. The specific surface area of the oxide particle (as measured by the BET specific surface area measuring method using nitrogen) is preferably from 10 to 1,000 m²/g, more preferably from 20 to 500 m²/g, and most preferably from 50 to 300 m²/g. This inorganic oxide particle may be used by dispersing its powder in the dry state in an organic solvent but, for example, a liquid dispersion of fine particulate oxide particle, known in the art as a solvent dispersion sol of the above-described oxide, can be used directly.

[Dispersion Method]

In the present invention, for preparing the inorganic oxide fine particle by dispersing its powder form in a solvent, a dispersant may be used. Use of a dispersant having an anionic group is preferred in the present invention.

As for the anionic group, a group having an acidic proton, such as carboxyl group, sulfonic acid group (sulfo), phosphoric acid group (phosphono) and sulfonamide group, or a salt thereof is effective. In particular, a carboxyl group, a sulfonic acid group, a phosphonic acid group and a salt thereof are preferred, and a carboxyl group and a phosphoric acid group are more preferred. For the purpose of more improving the dispersibility, a plurality of anionic groups may be contained. The average number of anionic groups is preferably 2 or more, more preferably 5 or more, still more preferably 10 or more. Also, plural kinds of anionic groups may be contained in one molecule of the dispersant.

The dispersant may further contain a crosslinking or polymerizable functional group. Examples of the crosslinking or polymerizable functional group include an ethylenically unsaturated group (e.g., (meth)acryloyl, allyl, styryl, vinyloxy) capable of undergoing addition reaction/polymerization reaction by the effect of a radical species; a cationic polymerizable group (e.g., epoxy, oxatanyl, vinyloxy); and a polycondensation reactive group (e.g., hydrolyzable silyl, N-methylol). Among these, a functional group having an ethylenically unsaturated group is preferred.

In the present invention, a disperser may be used for pulverizing the inorganic oxide particle. Examples of the disperser include a sand grinder mill (e.g., bead mill with pin), a high-speed impeller, a pebble mill, a roller mill, an attritor and a colloid mill. Among these, a sand grinder mill and a high-speed impeller are preferred. Also, a preliminary dispersion treatment may be performed. Examples of the disperser for use in the preliminary dispersion treatment include a ball mill, a three-roll mill, a kneader and an extruder.

[High Refractive Index Inorganic Fine Particle]

For elevating the refractive index of the layer, the hardcoat layer preferably contains, in addition to the above-described matting particle, an inorganic fine particle comprising an oxide of at least one metal selected from the group consisting of titanium, zirconium, aluminum, indium, zinc, tin and antimony and having an average particle diameter of 0.001 to 0.2 μm, preferably from 0.001 to 0.1 μm, more preferably from 0.001 to 0.06 μm. Specific examples of the inorganic fine particle for use in the hardcoat layer include TiO₂, ZrO₂, Al₂O₃, In₂O₃, ZnO, SnO₂, Sb₂O₃ and tin-doped indium oxide (ITO). Among these, TiO₂ and ZrO₂ are preferred from the standpoint of elevating the refractive index. It is also preferred that the surface of the inorganic fine particle is subjected to a silane coupling treatment or a titanium coupling treatment. A surface treating agent having a functional group capable of reacting with the binder species on the filler surface is preferably used.

The amount of the inorganic fine particle added is preferably from 10 to 90 mass %, more preferably from 20 to 80 mass %, still more preferably from 30 to 75 mass %, based on the entire mass of the hardcoat layer.

Incidentally, such an inorganic fine particle has a particle diameter sufficiently smaller than the wavelength of light and therefore, causes no scattering and the dispersion obtained by dispersing the filler in the binder polymer behaves as an optically uniform substance.

The mixture of the binder and the inorganic fine particle in the hardcoat layer preferably has a refractive index of 1.57 to 2.00, more preferably from 1.60 to 1.80. The refractive index in this range can be attained by appropriately selecting the kind and amount ratio of the binder and the inorganic fine particle. How to select these can be easily known in advance by an experiment.

[Solvent of Coating Solution]

An organic solvent liquid dispersion of the above-described inorganic oxide fine particle according to the present invention is used as the fine particle component and combined with a binder to prepare a coating composition, and a hardcoat layer can be formed from this composition. The solvent of the coating composition is not limited, but at least two kinds of volatile solvents are preferably used. For example, at least two members selected from alcohols and derivatives thereof, ethers, ketones, hydrocarbons and esters are preferably used in combination. The solvents can be selected by taking account of the solubility of binder component, the stability of inorganic fine particle, the control of viscosity of the coating solution, and the like. By using two or more kinds of solvents in combination, fine particles can be disposed in the film in a controlled arrangement as specified in the present invention. The boiling point of the solvent for use in the present invention is preferably from 50 to 250° C., more preferably from 65 to 200° C. The dielectric constant at 20° C. is preferably from 1 to 50, more preferably from 5 to 30. When a solvent having a dielectric constant of 10 or more is contained in an amount of 10 mass % based on the inorganic fine particle, this is preferred in view of dispersion stability.

Examples of the solvent which can be used in the present invention include, but are not limited to, the followings:

alcohols and derivatives thereof (e.g., methanol, ethanol, n-propanol, isopropyl alcohol, n-butanol, isobutanol, secondary butanol, tertiary butanol, n-amyl alcohol, isoamyl alcohol, secondary amyl alcohol, 3-pentanol, tertiary amyl alcohol, n-hexanol, methyl amyl alcohol, 2-ethyl butanol, n-heptanol, 2-heptanol, 3-heptanol, n-octanol, 2-octanol, 2-ethyl hexanol, 3,5,5-trimethyl hexanol, nonanol, benzyl alcohol, ethylene glycol, ethylene glycol monomethyl ether, ethylene glycol monomethyl ether acetate, ethylene glycol monoethyl ether, ethylene glycol diethyl ether, ethylene glycol monoethyl ether acetate, ethylene glycol isopropyl ether, ethylene glycol monobutyl ether, ethylene glycol dibutyl ether, ethylene glycol monobutyl ether acetate, ethylene glycol isoamyl ether, methoxy-methoxyethanol, methoxypropanol, butoxyethanol, ethylene glycol monoacetate, ethylene glycol diacetate, diethylene glycol, diethylene glycol monomethyl ether, diethylene glycol monoethyl ether, diethylene glycol diethyl ether, propylene glycol, propylene glycol monomethyl ether, propylene glycol monoethyl ether, propylene glycol monobutyl ether, dipropylene glycol monomethyl ether, dipropylene glycol monomethyl ether, dipropylene glycol monoethyl ether);

ethers (e.g., isopropyl ether, n-butyl ether, isoamyl ether, methyl phenyl ether, ethyl phenyl ether);

ketones (e.g., acetone, methyl acetone, methyl ethyl ketone, methyl-n-propyl ketone, methyl-n-butyl, methyl isobutyl ketone, methyl-n-amyl ketone, methyl-n-hexyl ketone, diethyl ketone, ethyl-n-butyl ketone, di-n-propyl ketone, diisobutyl ketone, acetonylacetone, diacetone alcohol, cyclohexanone, methylcyclohexanone);

hydrocarbons (e.g., n-hexane, isohexane, n-heptane, n-octane, isooctane, n-decane, toluene, xylene, ethylbenzene, diethylbenzene, isopropylbenzene, amylbenzene); and

esters (e.g., propyl formate, n-butyl formate, isobutyl formate, amyl formate, ethyl acetate, n-propyl acetate, isopropyl acetate, n-butyl acetate, isobutyl acetate, secondary butyl acetate, n-amyl acetate, isoamyl acetate, methylisoamyl acetate, methoxybutyl acetate, secondary hexyl acetate, 2-ethylbutyl acetate, 2-ethylhexyl acetate, cyclohexyl acetate, methylcyclohexyl acetate, benzyl acetate, methyl propionate, ethyl propionate, n-butyl propionate, isoamyl propionate, methyl butyrate, ethyl butyrate, n-butyl butyrate, isoamyl butyrate, ethyl oxyisobutyrate, methyl acetoacetate, ethyl acetoacetate, isoamyl isovalerate, methyl lactate, ethyl lactate, n-butyl lactate, isobutyl lactate, n-amyl lactate, isoamyl lactate, methyl benzoate, diethyl oxalate).

A combination of at least two members selected from alcohols and derivatives thereof, ketones and esters is preferred, and a combination of three members selected therefrom is more preferred. For example, two or three members selected from methyl ethyl ketone, methyl isobutyl ketone, cyclohexanone, 2-methoxypropanol, 2-butoxyethanol, isopropyl alcohol and toluene may be preferably used in combination.

The inorganic fine particle chemically modified so as to reduce the surface free energy generally has high affinity for a high-polarity organic solvent. By making use of this property, when a high-polarity solvent is incorporated into the coating composition, uneven distribution of the low refractive index fine particle to the surface can be accelerated.

The polarity of the organic solvent can be expressed by a solubility parameter (SP value). From the above-described aspect, the curable composition of the present invention is preferably formed from a curable composition containing a solvent having an SP value of 9.5 or more, more preferably 10.0 or more.

Incidentally, in the case where the curable composition for the formation of a hardcoat layer contains an organic solvent having an SP value of 9.5 or more in the present invention, the organic solvent is preferably contained in an amount of 5 mass % or more, more preferably 10 mass % or more, still more preferably 15 mass % or more, based on the curable composition.

Furthermore, in the present invention, when the curable composition for the formation of a hardcoat layer contains an organic solvent having an SP value of 10.0 or more, the organic solvent is preferably contained in an amount of 5 mass % or more, more preferably 10 mass % or more, still more preferably 15 mass % or more, based on the curable composition.

<Solubility Parameter (SP Value)>

The solubility parameter (SP value) as used in the present invention is a value determined according to the formula: σ[(ΔH−RT)/VL]^{1/2} (wherein a: solubility parameter, ΔH: heat of evaporation, VL: molar volume, and R: gas constant). As for ΔH, a value of ΔH298=23.7Tb+0.020Tb²-2950 (wherein Tb: boiling point) calculated from the boiling point according to the Hidebrand rule is employed. Accordingly, the solubility parameter used here is also a value at 298° K. Incidentally, some solubility parameters determined by the Hidebrand rule are specifically described in J. Brandrup, E. H. Immergut and E. A. Grulke, POLYMER HANDBOOK FORTH EDITION, VII/688-694, JOHN WILEY & SONS, INC. (1998). Also, the calculation method of the solubility parameter according to the Hidebrand rule is described in J. H. Hildebrand, Solubility of Nonelectrolytes, 424-427, Reinhold Publishing Co. (1950).

The SP values of representative compounds are shown in Table 1.

TABLE 1

| | SP | | |
|---|---|---|---|
| Solvent | value | Solvent | SP value |
| Dimethylsiloxane | 5.5 | Isopentyl alcohol | 10.0 |
| Neopentane | 6.3 | o-Dichlorobenzene | 10.0 |
| Diisopropyl ether | 6.9 | Acetic acid | 10.1 |
| Pentane | 7.0 | m-Cresol | 10.2 |
| Diethyl ether | 7.4 | 1-Octanol | 10.3 |
| Octane | 7.6 | Cyclopentanone | 10.4 |
| Diisobutyl ketone | 7.8 | tert-Butyl alcohol | 10.6 |
| Diethylamine | 8.0 | Pyridine | 10.7 |
| Dicyclohexane | 8.2 | 2-Butanol | 10.8 |
| Methyl isobutyl ketone | 8.4 | 1-Pentanol | 10.9 |
| Dipentene | 8.5 | 1-Butanol | 11.4 |
| 2-Heptane | 8.5 | Cyclohexanol | 11.4 |
| Butyl Acetate | 8.5 | Isopropyl alcohol | 11.5 |
| Carbon tetrachloride | 8.6 | 1-Methoxy-2-propanol | 11.7 |
| Propylbenzene | 8.6 | Acetonitrile | 11.9 |
| Xylene | 8.8 | Benzyl alcohol | 12.1 |
| p-Chlorotoluene | 8.8 | Diethylene glycol | 12.1 |
| Butylaldehyde | 9.0 | Ethanol | 12.7 |
| Benzene | 9.2 | Methanol | 14.5 |
| Styrene | 9.3 | Ethylene glycol | 14.6 |
| Methyl ethyl ketone | 9.3 | Glycerol | 16.5 |
| Acetone | 9.9 | water | 23.4 |
| Cyclohaxanone | 9.9 | | |

In the present invention, in order to obtain a controlled arrangement of the inorganic fine particle in the layer, the binder is preferably composed of at least one polymerizable composition having a weight average molecular weight of 5,000 or more and at least one polymerizable compound having a weight average molecular weight of less than 5,000. As for specific examples of the composition having a weight average molecular weight of 5,000 or more, a copolymer having a (meth)acryloyl group in the side chain and a high molecular weight compound containing fluorocarbon or dimethylsiloxane are preferred. As for the compound having a weight average molecular weight of less than 5,000, a polyfunctional acrylate monomer and a partial condensate of the compound represented by formula (II) having a (meth)acryloyl group are preferred.

(Other Additives)

In the hardcoat layer of the present invention, for the purpose of imparting properties such as antifouling property, chemical resistance and slipperiness, known antifouling agent, slipping agent and the like, such as polysiloxane compound and fluorine-based compound, may be appropriately added.

(Polysiloxane Compound)

Preferred examples of the polysiloxane compound include those having a substituent at the terminal and/or on the side chain of the compound chain containing a plurality of dimethylsilyloxy units as the repeating unit. In the compound chain containing a dimethylsilyloxy group as the repeating unit, a structural unit other than dimethylsilyloxy may be contained.

A plurality of substituents, which may be the same or different, are preferably substituted. Preferred examples of the substituent include a group containing an acryloyl group, a methacryloyl group, a vinyl group, an allyl group, a cinnamoyl group, an epoxy group, an oxetanyl group, a hydroxyl group, a fluoroalkyl group, a polyoxyalkylene group, a carboxyl group, an amino group or the like. The molecular weight is not particularly limited but is preferably 100,000 or less, more preferably 50,000 or less, and most preferably from 3,000 to 30,000.

In the case where the hardcoat layer of the present invention is formed of a radical polymerizable binder, the polymerizable polysiloxane compound contained in the curable composition for forming the hardcoat layer is preferably a radical polymerizable polysiloxane compound in view of antifouling durability.

Specific examples of such a compound include, as a (meth)acrylate-terminated siloxane compound, X-22-164A, X-22-164B, X-22-164C, X-22-2404, X-22-174D, X-22-8201 and X-22-2426 (produced by Shin-Etsu Chemical Co., Ltd.).

In the case where the hardcoat layer of the present invention is formed of a cationic polymerizable binder, the polymerizable polysiloxane compound is preferably a cationic polymerizable polysiloxane compound similarly in view of antifouling durability.

Specific examples of such a compound include KF-105, X-22-163A, X-22-163B, X-22-163C, X-22-173DX, KF-1001, KF-101, X-22-169AS, X-22-169B, KF-102, X-22-3667 and X-22-4741 (produced by Shin-Etsu Chemical Co., Ltd.).

In the case of adding such an additive, the coated amount of the additive is from 0.4 to 45 mg/m², preferably from 1 to 30 g/m², more preferably from 2 to 20 mg/m², still more preferably from 3 to 8 mg/m².

The content of the active energy ray-curable silicone resin in the curable composition of the present invention is preferably from 0.001 to 0.2 mass %, more preferably from 0.005 to 0.1 mass %, and most preferably from 0.01 to 0.05 mass %, based on all active energy ray-curable resins used in the curable composition.

[Transparent Plastic Substrate]

The optical film of the present invention is produced by forming a cured layer on a transparent substrate (hereinafter sometimes referred to as a “transparent support”). The light transmittance of the transparent plastic substrate is preferably 80% or more, more preferably 86% or more. The haze of the transparent support is preferably 2.0% or less, more preferably 1.0% or less. The refractive index of the transparent plastic substrate is preferably from 1.4 to 1.7.

Examples of the material for the transparent plastic film include a cellulose ester, a polyamide, a polycarbonate, a polyester (e.g., polyethylene terephthalate, polyethylene naphthalate, poly-1,4-cyclohexanedimethylene terephthalate, polyethylene-1,2-diphenoxyethane-4,4′-dicarboxylate, polybutylene terephthalate), a polystyrene (e.g., syndiotactic polystyrene), a polyolefin (e.g., polypropylene, polyethylene, polymethylpentene), a polysulfone, a polyethersulfone, a polyarylate, a polyetherimide, a polymethyl methacrylate and a polyether ketone. Among these, a cellulose ester, a polycarbonate, a polyethylene terephthalate and a polyethylene naphthalate are preferred.

[Cellulose Acylate Film]

Particularly, in the case of using the optical film of the present invention for a liquid crystal display device, a cellulose acylate film is preferred. The cellulose acylate is produced by esterifying a cellulose. As for the cellulose before esterification, linter, kenaf or pulp is purified and used.

(Cellulose Acylate)

The cellulose acylate as used in the present invention means a fatty acid ester of cellulose, but a lower fatty acid ester is preferred. Furthermore, a fatty acid ester film of cellulose is preferred.

The lower fatty acid means a fatty acid having a carbon atom number of 6 or less. A cellulose acylate having a carbon atom number of 2 to 4 is preferred. In particular, a cellulose acetate is preferred. It is also preferred to use a mixed fatty acid ester such as cellulose acetate propionate and cellulose acetate butyrate.

The viscosity average degree of polymerization (Dp) of the cellulose acylate is preferably 250 or more, more preferably 290 or more. Also, the cellulose acylate preferably has a narrow molecular weight distribution indexed by Mw/Mn (Mw: mass average molecular weight, Mn: number average molecular weight) according to gel permeation chromatography. Specifically, the Mw/Mn value is preferably from 1.0 to 5.0, more preferably from 1.0 to 3.0, still more preferably from 1.0 to 2.0.

A cellulose acylate having an acetylation degree of 55.0 to 62.5% is preferably used as the transparent support. The acetylation degree is more preferably from 57.0 to 62.0%, still more preferably 59.0 to 61.5%. The acetylation degree means the amount of acetic acid bonded per unit mass of cellulose. The acetylation degree can be determined according to the measurement and calculation of acetylation degree in ASTM:D-817-91 (Test Method of Cellulose Acetate, etc.).

In the cellulose acylate, the hydroxyl is not equally substituted to the 2-, 3- and 6-positions of cellulose, but the substitution degree at the 6-position tends to become small. In the cellulose acylate for use in present invention, the substitution degree at the 6-position of cellulose is preferably equal to or larger than that at the 2- or 3-position. The proportion of the substitution degree at the 6-position is preferably from 30 to 40%, more preferably from 31 to 40%, and most preferably from 32 to 40%, based on the total of the substitution degrees at the 2-, 3- and 6-positions.

For the purpose of adjusting the properties of the film, such as mechanical property (e.g., film strength, curl, dimensional stability, slipperiness) and durability (e.g., moisture and heat resistance, weather resistance), various additives may be used in the transparent support. Examples of the additive include a plasticizer (e.g., phosphoric acid esters, phthalic acid esters, esters of polyol and fatty acid), an ultraviolet inhibitor (e.g., hydroxybenzophenone-based compound, benzotriazole-based compound, salicylic acid ester-based compound, cyanoacrylate-based compound), a deterioration inhibitor (e.g., antioxidant, peroxide decomposing agent, radical inhibitor, metal inactivating agent, acid scavenger, amine), a fine particle (e.g., SiO₂, Al₂O₃, TiO₂, BaSO₄, CaCO₃, MgCO₃, talc, kaolin), a release agent, an antistatic agent and an infrared absorbent.

These additives are described in detail in JIII Journal of Technical Disclosure, No. 2001-1745, pp. 17-22, Japan Institute of Invention and Innovation (Mar. 15, 2001), and the materials described therein are preferably used.

The amount of such an additive used is preferably from 0.01 to 20 mass %, more preferably from 0.05 to 10 mass %, based on the transparent support.

[Surface Treatment]

The transparent support may be subjected to a surface treatment.

Examples of the surface treatment include a chemical treatment, a mechanical treatment, a corona discharge treatment, a flame treatment, an ultraviolet radiation treatment, a high-frequency treatment, a glow discharge treatment, an active plasma treatment, a laser treatment, a mixed acid treatment and an ozone oxidation treatment. Specific examples thereof include the contents described in JIII Journal of Technical Disclosure, No. 2001-1745, pp. 30-31 (Mar. 15, 2001) and JP-A-2001-9973. Among these treatments, a glow discharge treatment, an ultraviolet radiation treatment, a corona discharge treatment and a flame treatment are preferred, and a glow discharge treatment and an ultraviolet treatment are more preferred.

[Saponification Treatment]

In the case of using the optical film of the present invention for a liquid display device, the optical film is disposed on the outermost surface of the display by providing a pressure-sensitive adhesive layer on one surface. In the case where the transparent support is triacetyl cellulose, triacetyl cellulose is used as the protective film for protecting the polarizing layer of a polarizing plate and therefore, in view of the cost, the optical film of the present invention is preferably used directly as the protective film.

In the case where the optical film of the present invention is disposed on the outermost surface of a display, for example, by providing a pressure-sensitive adhesive layer on one surface or used directly as the protective film of a polarizing plate, for ensuring satisfactory adhesion, a saponification treatment is preferably performed after an outermost layer mainly comprising a fluorine-containing polymer is formed on a transparent support. The saponification treatment is performed by a known method, for example, by dipping the film in an alkali solution for an appropriate time period. After dipping in an alkali solution, the film is preferably well washed with water or dipped in a dilute acid to neutralize the alkali component so as to prevent the alkali component from remaining in the film.

By performing a saponification treatment, the surface of the transparent support on the side opposite the surface having the outermost layer is hydrophilized.

The hydrophilized surface is effective particularly for improving the adhesive property to a deflecting film mainly comprising a polyvinyl alcohol. Furthermore, the hydrophilized surface hardly allows for attachment of dusts in the air and therefore, dusts scarcely intrude into the space between the deflecting film and the optical film at the bonding to a deflecting film, so that point defects due to dusts can be effectively prevented.

The saponification treatment is preferably performed such that the surface of the transparent support on the side opposite the surface having the outermost layer has a contact angle with water of 40° or less, more preferably 30° or less, still more preferably 20° or less.

The specific method for the alkali saponification treatment can be selected from the following two methods (1) and (2). The method (1) is advantageous in that the treatment can be performed by the same process as that for general-purpose triacetyl cellulose film, but since the antireflection film surface is also saponified, there may arise a problem that the film is deteriorated due to alkali hydrolysis of the surface or the remaining solution for saponification treatment causes staining. In such a case, the method (2) is advantageous, though this is a special process.

(1) After the formation of an antireflection layer on the transparent support, the support is dipped at least once in an alkali solution, whereby the back surface of the film is saponified.

(2) Before or after the formation of an antireflection layer on the transparent support, an alkali solution is applied to the surface of the optical film on the side opposite the surface where the optical film is formed, and then the support is heated and washed with water and/or neutralized, whereby only the back surface of the film is saponified.

[Coating Film Forming Method]

The optical film of the present invention can be formed by the following method, but the present invention is not limited to this method.

First, a coating solution containing components for forming each layer is prepared. The coating solution prepared is coated on a transparent support by a dip coating method, an air knife coating method, a curtain coating method, a roller coating method, a wire bar coating method, a gravure coating method or an extrusion coating method (see, U.S. Pat. No. 2,681,294), and then heated and dried. Out of these coating methods, when the coating solution is coated by a gravure coating method, a coating solution in a small coated amount as in each layer of the antireflection film can be coated with high film thickness uniformity and this is preferred. Among the gravure coating methods, a microgravure coating method is more preferred, because the film thickness uniformity is high.

Furthermore, a coating solution in a small coated amount can be coated with high film thickness uniformity also by a die coating method. The die coating method is a pre-measuring system and therefore, is advantageous in that the control of film thickness is relatively easy and the solvent in the coated part is less transpired. Two or more layers may be coated simultaneously. The simultaneous coating method is described in U.S. Pat. Nos. 2,761,791, 2,941,898, 3,508,947 and 3,526,528, and Yuji Harasaki, Coating Kogaku (Coating Engineering), page 253, Asakura Shoten (1973).

[Polarizing Plate]

The polarizing plate mainly comprises a polarizing film and two protective films sandwiching the polarizing film from both sides. The optical film of the present invention is preferably used for at least one protective film out of two protective films sandwiching the polarizing film from both sides. By arranging the optical film of the present invention to serve also as a protective film, the production cost of the polarizing plate can be reduced. Furthermore, by using the optical film of the present invention as an outermost surface layer, a polarizing plate prevented from the projection of outside light or the like and excellent in the scratch resistance, antifouling property and the like can be obtained.

As for the polarizing film, a known polarizing film or a polarizing film cut out from a lengthy polarizing film with the absorption axis of the polarizing film being neither parallel nor perpendicular to the longitudinal direction, may be used. The lengthy polarizing film with the absorption axis of the polarizing film being neither parallel nor perpendicular to the longitudinal direction is produced by the following method.

That is, this is a polarizing film obtained by continuously feeding a polymer film and stretching the film by applying a tension while holding both edges of the film with holding means and can be produced according to a stretching method where the film is stretched to 1.1 to 20.0 times at least in the film width direction, the holding devices at both edges of the film are moved to create a difference in the travelling speed of 3% or less in the longitudinal direction, and the film travelling direction is bent in the state of the film being held at both edges such that the angle made by the film travelling direction at the outlet in the step of holding both edges of the film and the substantial stretching direction of the film inclines at 20 to 70°. Particularly, a polarizing film produced with an inclination angle of 45° is preferred in view of productivity.

The stretching method of a polymer film is described in detail in JP-A-2002-86554 (paragraphs [0020] to [0030]).

In the case of using the optical film of the present invention as a surface protective film on one side of the polarizing film, the optical film can be preferably used for a transmissive, reflective or transflective liquid crystal display device in a mode such as twisted nematic (TN) mode, super-twisted nematic (STN) mode, vertical alignment (VA) mode, in-plane switching (IPS) mode or optically compensated bend cell (OCB) mode.

The VA-mode liquid crystal cell includes (1) a VA-mode liquid crystal cell in a narrow sense where rod-like liquid crystalline molecules are oriented substantially in the vertical alignment at the time of not applying a voltage and oriented substantially in the horizontal alignment at the time of applying a voltage (described in JP-A-2-176625); (2) a (MVA-mode) liquid crystal cell where the VA mode is modified to a multi-domain system for enlarging the viewing angle (described in SID97, Digest of Tech. Papers (preprints), 28, 845 (1997)); (3) a (n-ASM-mode) liquid crystal cell where rod-like liquid crystalline molecules are oriented substantially in the vertical alignment at the time of not applying a voltage and oriented in the twisted multi-domain alignment at the time of applying a voltage (described in preprints of Nippon Ekisho Toronkai (Liquid Crystal Forum of Japan), 58-59 (1998)); and (4) a SURVAIVAL-mode liquid crystal cell (reported in LCD International 98).

For the application to a VA-mode liquid crystal cell, a polarizing plate prepared by combining a biaxially stretched triacetyl cellulose film with the optical film of the present invention is preferred. As for the production method of a biaxially stretched triacetyl cellulose film, the method described, for example, in JP-A-2001-249223 and JP-A-2003-170492 is preferably used.

The OCB-mode liquid crystal cell is a liquid crystal display device using a liquid crystal cell of bend alignment mode where rod-like liquid crystalline molecules are aligned substantially in the reverse direction (symmetrically) between the upper part and the lower part of the liquid crystal cell, and this is disclosed in U.S. Pat. Nos. 4,583,825 and 5,410,422. Since rod-like liquid crystalline molecules are aligned symmetrically between the upper part and the lower part of the liquid crystal cell, the liquid crystal cell of bend alignment mode has a self-optically compensating ability. Accordingly, this liquid crystal mode is also called an OCB (optically compensatory bend) liquid crystal mode. A liquid crystal display device of bend alignment mode is advantageous in that the response speed is fast.

In the ECB-mode liquid crystal cell, rod-like liquid crystalline molecules are oriented substantially in the horizontal alignment at the time of not applying a voltage. This is most popularly used as a color TFT liquid crystal display device and is described in a large number of publications such as EL, PDP LCD Display, Toray Research Center (2001).

Particularly, in the case of a TN-mode or IPS-mode liquid crystal display device, as described in JP-A-2001-100043 and the like, an optical compensation film having an effect of enlarging the viewing angle is preferably used for the protective film on the surface opposite the optical film of the present invention out of front and back two protective films of a polarizing film, because a polarizing plate having an antireflection effect and a viewing angle-enlarging effect with a thickness of one polarizing plate can be obtained.

### EXAMPLES

The present invention is described in greater detail below by referring to Examples, but the present invention is not limited thereto. Unless otherwise indicated, the “parts” and “%” are on the mass basis.

(Preparation of Silica Liquid Dispersion A)

8 Parts of acryloyloxypropyltrimethoxysilane (produced by Shin-Etsu Chemical Co., Ltd.), 2 parts of tridecafluorooctyltrimethoxysilane (produced by GE Toshiba Silicones Co., Ltd.) and 1.5 parts of diisopropoxyaluminum ethyl acetate were added and mixed to 500 parts of a hollow silica fine particle sol (Isopropyl Alcohol Silica Sol, average particle diameter: 40 nm, thickness of shell: 6 nm, silica concentration: 20 mass %, refractive index of silica particle: 1.30, prepared according to Preparation Example 4 of JP-A-2002-79616 by changing the size), and then 9 parts of ion exchanged water was added. After allowing the reaction to proceed at 60° C. for 8 hours, the reaction solution was cooled to room temperature, and 1.8 parts of acetylacetone was added.

While adding cyclohexanone to 500 g of the obtained liquid dispersion to keep a nearly constant silica content, solvent displacement by distillation under reduced pressure was performed at a pressure of 20 kPa. Generation of foreign matters in the liquid dispersion was not observed. Subsequently, the solid content concentration was adjusted by removing cyclohexanone and when the solid content concentration became 22 mass %, the viscosity was 9 mPa·s at 25° C. The residual isopropyl alcohol amount in the obtained Liquid Dispersion A was analyzed by gas chromatography and found to be 1.0%.

(Preparation of Silica Liquid Dispersion B)

10 Parts of acryloyloxypropyltrimethoxysilane (produced by Shin-Etsu Chemical Co., Ltd.) and 1.5 parts of diisopropoxyaluminum ethyl acetate were added and mixed to 500 parts of a hollow silica fine particle sol (Isopropyl Alcohol Silica Sol, average particle diameter: 40 nm, thickness of shell: 6 nm, silica concentration: 20 mass %, refractive index of silica particle: 1.30, prepared according to Preparation Example 4 of JP-A-2002-79616 by changing the size), and then 9 parts of ion exchanged water was added. After allowing the reaction to proceed at 60° C. for 8 hours, the reaction solution was cooled to room temperature, and 1.8 parts of acetylacetone was added.

While adding cyclohexanone to 500 g of the obtained liquid dispersion to keep a nearly constant silica content, solvent displacement by distillation under reduced pressure was performed at a pressure of 20 kPa. Generation of foreign matters in the liquid dispersion was not observed. Subsequently, the solid content concentration was adjusted with cyclohexanone and when the solid content concentration became 22 mass %, the viscosity was 9 mPa·s at 25° C. The residual isopropyl alcohol amount in the obtained Liquid Dispersion B was analyzed by gas chromatography and found to be 1.0%.

[Preparation of Coating Solution for Hardcoat Layer]
{Composition of Coating Solution (HCL-1) for Hardcoat Layer}

| | | |
|---|---|---|
| UV-Curable resin: “DPHA” {produced by Nippon Kayaku | 450.0 | parts |
| Co., Ltd.} | | |
| Isopropyl alcohol | 60.0 | parts |
| Methyl ethyl ketone | 280.0 | parts |
| Photoradical polymerization initiator: “Irgacure 907” | 12.0 | parts |
| [produced by Ciba Specialty Chemicals] | | |
| Silica Liquid Dispersion A | 50.0 | parts |
| “IPA-ST” (an IPA liquid dispersion of silica particle of 15 nm, | 600.0 | parts |
| solid content concentration: 30%) {produced by | | |
| Nissan Chemical Industries, Ltd.} | | |

{Composition of Coating Solution (HCL-2) for Hardcoat Layer}

| | | |
|---|---|---|
| UV-Curable resin: “DPHA” | 450.0 | parts |
| Isopropyl alcohol | 60.0 | parts |
| Methyl ethyl ketone | 280.0 | parts |
| Photopolymerization initiator: “Irgacure 907” | 12.0 | parts |
| Silica Liquid Dispersion B | 50.0 | parts |
| “IPA-ST” (an IPA liquid dispersion of silica particle of 15 nm, | 600.0 | parts |
| solid content concentration: 30%) {produced by | | |
| Nissan Chemical Industries, Ltd.} | | |

{Composition of Coating Solution (HCL-3) for Hardcoat Layer}

| | | |
|---|---|---|
| UV-Curable resin: “DPHA” {produced by Nippon Kayaku | 450.0 | parts |
| Co., Ltd.} | | |
| Isopropyl alcohol | 60.0 | parts |
| Methyl ethyl ketone | 280.0 | parts |
| Photoradical polymerization initiator: “Irgacure 907” | 12.0 | parts |
| [produced by Ciba Specialty Chemicals] | | |
| Silica Liquid Dispersion A | 50.0 | parts |
| “IPA-ST” (an IPA liquid dispersion of silica particle of 15 nm, | 600.0 | parts |
| solid content concentration: 30%) {produced by | | |
| Nissan Chemical Industries, Ltd.} | | |
| Silicone oil: “X-22-164C” [produced by Shin-Etsu | 0.1 | part |
| Chemical Co., Ltd.] | | |

{Composition of Coating Solution (HCL-4) for Hardcoat Layer}

| | | |
|---|---|---|
| UV-Curable resin: “DPHA” | 450.0 | parts |
| Methyl ethyl ketone | 300.0 | parts |
| “Irgacure 907” | 12.0 | parts |
| Silica Liquid Dispersion A | 100.0 | parts |
| “MEK-ST” (an IPA liquid dispersion of silica particle of | 600.0 | parts |
| 15 nm, solid content concentration: 30%) {produced by | | |
| Nissan Chemical Industries, Ltd.} | | |
| Silicone oil: “X-22-164C” | 0.1 | part |

{Composition of Coating Solution (HCL-5) for Hardcoat Layer}

| | | |
|---|---|---|
| UV-Curable resin: “PETA” {produced by Nippon Kayaku | 600.0 | parts |
| Co., Ltd.} | | |
| “Irgacure 184” | 20.0 | parts |
| Silica Liquid Dispersion A | 50.0 | parts |
| Toluene liquid dispersion (30%) of crosslinked | 17.0 | parts |
| polystyrene particle: “SX-350H” (average particle | | |
| diameter: 3.5 μm, a 30 wt % toluene liquid dispersion | | |
| produced by Soken Kagaku K.K.) | | |
| Toluene liquid dispersion (30%) of crosslinked acryl- | 133.0 | parts |
| styrene particle: “SX-350HL” (average particle diameter: | | |
| 3.5 μm, a 30 wt % toluene liquid dispersion produced by | | |
| Soken Kagaku K.K.) | | |
| Toluene | 287.0 | parts |
| Cyclohexanone | 98.0 | parts |
| Silicone oil: “X-22-164C” | 0.1 | part |

{Composition of Coating Solution (HCL-6) for Antiglare Hardcoat Layer}

| | | |
|---|---|---|
| UV-Curable resin: “PETA” {produced by Nippon Kayaku | 600.0 | parts |
| Co., Ltd.} | | |
| “Irgacure 184” | 20.0 | parts |
| Silica Liquid Dispersion B | 50.0 | parts |
| Toluene liquid dispersion (30%) of crosslinked | 17.0 | parts |
| polystyrene particle: “SX-350H” (average particle | | |
| diameter: 3.5 μm, a 30 wt % toluene liquid dispersion | | |
| produced by Soken Kagaku K.K.) | | |
| Toluene liquid dispersion (30%) of crosslinked acryl- | 133.0 | parts |
| styrene particle: “SX-350HL” (average particle diameter: | | |
| 3.5 μm, a 30 wt % toluene liquid dispersion produced by | | |
| Soken Kagaku K.K.) | | |
| Toluene | 287.0 | parts |
| Cyclohexanone | 98.0 | parts |
| Silicone oil: “X-22-164C” | 0.1 | part |

{Composition of Coating Solution (HCL-7) for Anti-glare Hardcoat Layer}

| | | |
|---|---|---|
| UV-Curable resin: “PETA” (produced by Nippon Kayaku | 600.0 | parts |
| Co., Ltd.) | | |
| “Irgacure 184” | 20.0 | parts |
| Silica Liquid Dispersion A | 50.0 | parts |
| Toluene liquid dispersion (30%) of crosslinked | 17.0 | parts |
| polystyrene particle: “a 30 wt % toluene liquid dispersion | | |
| of particles with average particle diameter of 8.0 μm and | | |
| having the same composition as that of SX-350H” | | |
| Toluene liquid dispersion (30%) of crosslinked acrylic- | 133.0 | parts |
| styrene particle: “a 30 wt % toluene liquid dispersion of | | |
| particles with average particle diameter of 8.0 μm and | | |
| having the same composition as that of SX-350H” | | |
| Toluene | 287.0 | parts |
| Cyclohexanone | 98.0 | parts |
| Silicone oil: “X-22-164C” | 0.1 | part |

{Composition of Coating Solution (HCL-8) for Anti-glare Hardcoat Layer}

| | | |
|---|---|---|
| UV-Curable resin: “PETA” {produced by Nippon Kayaku | 600.0 | parts |
| Co., Ltd.} | | |
| “Irgacure 184” | 20.0 | parts |
| Silica Liquid Dispersion B | 50.0 | parts |
| Toluene liquid dispersion (30%) of crosslinked | 17.0 | parts |
| polystyrene particle: “a 30 wt % toluene liquid dispersion | | |
| of particles with average particle diameter of 8.0 μm and | | |
| having the same composition as that of SX-350H” | | |
| Toluene liquid dispersion (30%) of crosslinked acrylic- | 133.0 | parts |
| styrene particle: “a 30 wt % toluene liquid dispersion of | | |
| particles with average particle diameter of 8.0 μm and | | |
| having the same composition as that of SX-350H” | | |
| Toluene | 287.0 | parts |
| Cyclohexanone | 98.0 | parts |
| Silicone oil: “X-22-164C” | 0.1 | part |

{Composition of Coating Solution (HCL-9) for Hardcoat Layer}

| | | |
|---|---|---|
| Zirconia fine particle-containing hardcoat composition | 612.0 | parts |
| solution: “Desolite Z7404” {particle diameter: 20 nm, | | |
| produced by JSR CORP.} | | |
| UV-Curable resin: “DPHA” {produced by Nippon Kayaku | 234.0 | parts |
| Co., Ltd.} | | |
| Silica Liquid Dispersion A | 50.0 | parts |
| Silica particle: “KE-P150” {1.5 μm, produced by Nippon | 53.4 | parts |
| Shokubai Co., Ltd.} | | |
| Crosslinked PMMA particle: “MXS-300” {3 μm, | 20.4 | parts |
| produced by Soken Kagaku K.K.} | | |
| Methyl ethyl ketone (MEK) | 174.0 | parts |
| Cyclohexanone | 78.0 | parts |
| Silicone oil: “X-22-164C” | 0.1 | part |

{Composition of Coating Solution (HCL-10) for Antiglare Hardcoat Layer}

| | | |
|---|---|---|
| Zirconia fine particle-containing hardcoat composition | 612.0 | parts |
| solution: “Desolite Z7404” {particle diameter: 20 nm, | | |
| produced by JSR CORP.} | | |
| UV-Curable resin: “DPHA” {produced by Nippon Kayaku | 234.0 | parts |
| Co., Ltd.} | | |
| Silica Liquid Dispersion B | 50.0 | parts |
| Silica particle: “KE-P150” {1.5 μm, produced by Nippon | 53.4 | parts |
| Shokubai Co., Ltd.} | | |
| Crosslinked PMMA particle: “MXS-300” {3 μm, | 20.4 | parts |
| produced by Soken Kagaku K.K.} | | |
| Methyl ethyl ketone (MEK) | 174.0 | parts |
| Cyclohexanone | 78.0 | parts |
| Silicone oil: “X-22-164C” | 0.1 | part |

<Preparation of Antireflective Hardcoat Film>

### Example 1-1

A 1,340 mm-wide and 2,600 m-long triacetyl cellulose film, “TD80U” {produced by Fuji Photo Film Co., Ltd.}, in a roll form was unrolled as the support (substrate), and Coating Solution (HCL-1) for Hardcoat Layer, where surface-modified low refractive index fine particles were added, was coated directly thereon by using a doctor blade and a 50 mm-diameter microgravure roll having a gravure pattern with a line number of 135 lines/inch and a depth of 60 μm, under the condition of a transportation speed of 15 m/min and after drying at 60° C. for 150 seconds, irradiated with an ultraviolet ray at an illumination intensity of 400 mW/cm² and an irradiation dose of 250 mJ/cm² by using an air-cooled metal halide lamp of 160 W/cm (manufactured by Eye Graphics Co., Ltd.) while purging the system with nitrogen to keep an oxygen concentration of 1.0 vol % or less, thereby curing the coated layer and forming Hardcoat Layer (HC-1). The resulting film was taken up. After the curing, the rotation number of the gravure roll was adjusted so that the hardcoat layer could have an average thickness of 6.0 μm.

### Comparative Example 1-1 and Example 1-2

Samples of Comparative Example 1-1 and Example 1-2 were prepared by, as shown in Table 2, using Coating Solution (HCL-2) or (HCL-3) for Hardcoat Layer in place of Coating Solution (HCL-1) for Hardcoat Layer in Example 1-1 to form Hardcoat Layer (HC-2) or (HC-3), and taking up each film.

### Example 1-3

A 1,340 mm-wide and 2,600 m-long triacetyl cellulose film, “TD80U” {produced by Fuji Photo Film Co., Ltd.}, in a roll form was unrolled as the support (substrate), and Coating Solution (HCL-4) for Hardcoat Layer, where surface-modified low refractive index fine particles were added, was coated directly thereon by using a doctor blade and a 50 mm-diameter microgravure roll having a gravure pattern with a line number of 135 lines/inch and a depth of 60 μm, under the condition of a transportation speed of 15 m/min and after drying at 70° C. for 150 seconds, irradiated with an ultraviolet ray at an illumination intensity of 400 mW/cm² and an irradiation dose of 250 mJ/cm² by using an air-cooled metal halide lamp of 160 W/cm (manufactured by Eye Graphics Co., Ltd.) while purging the system with nitrogen to keep an oxygen concentration of 1.0 vol % or less, thereby curing the coated layer and forming Hardcoat Layer (HC-4). The resulting film was taken up. After the curing, the rotation number of the gravure roll was adjusted so that the hardcoat layer could have an average thickness of 6.0 μm.

### Example 2-1

A 1,340 mm-wide and 2,600 m-long triacetyl cellulose film, “TD80U” {produced by Fuji Photo Film Co., Ltd.}, in a roll form was unrolled as the support (substrate), and Coating Solution (HCL-5) for Antiglare Hardcoat Layer, where surface-modified low refractive index fine particles were added, was coated directly thereon by using a doctor blade and a 50 mm-diameter microgravure roll having a gravure pattern with a line number of 135 lines/inch and a depth of 60 μm, under the condition of a transportation speed of 15 m/min and after drying at 60° C. for 150 seconds, irradiated with an ultraviolet ray at an illumination intensity of 400 mW/cm² and an irradiation dose of 250 mJ/cm² by using an air-cooled metal halide lamp of 160 W/cm (manufactured by Eye Graphics Co., Ltd.) while purging the system with nitrogen to keep an oxygen concentration of 1.0 vol % or less, thereby curing the coated layer and forming Antiglare Hardcoat Layer (HC-5). The resulting film was taken up. After the curing, the rotation number of the gravure roll was adjusted so that the hardcoat layer could have an average thickness of 6.0 μm.

### Comparative Example 2-1

In the preparation of the antiglare hardcoat film of Example 2-1, Coating Solution (HCL-6) for Antiglare Hardcoat Layer was used in place of Coating Solution (HCL-5) for Antiglare Hardcoat Layer to form Antiglare Hardcoat Layer (HC-6), and the resulting film was taking up.

### Example 3-1

A 1340 mm-wide and 2600 m-long triacetyl cellulose film, “TD 80U” {produced by Fuji Photo Film Co., Ltd.}, in a roll form was unrolled as the support (substrate), and Coating Solution (HCL-7) for Anti-glare Hardcoat Layer, where the aforementioned surface-modified low refractive index fine particles had been added, was coated directly thereon by using a doctor blade and a 50 mm-diameter microgravure roll having a gravure pattern with a line number of 135 lines/inch and a depth of 60 μm, under the condition of a transportation speed of 15 m/min. After drying at 60° C. for 150 seconds, the coated product was irradiated with an ultraviolet ray at an illumination intensity of 400 mW/cm² and an irradiation dose of 250 mJ/cm² by using an air-cooled metal halide lamp of 160 W/cm (manufactured by Eye Graphics Co., Ltd.) while purging the system with nitrogen to keep an oxygen concentration of 1.0 vol. % or less, thereby curing the coated layer and forming an anti-glare Hardcoat Layer (HC-7). The resulting film was taken up. After the curing, the rotation number of the gravure roll was adjusted so that the anti-glare hardcoat layer could have an average thickness of 20 μm.

### Comparative Example 3-1

In contrast to the anti-glare hardcoat film as described in Example 3-1, Coating Solution (HCL-8) for anti-glare Hardcoat Layer was used instead of Coating Solution (HCL-7) for anti-glare Hardcoat Layer to form an anti-glare hardcoat layer (HC-8). The coated film was taken up.

### Example 4-1

A 1,340 mm-wide and 2,600 m-long triacetyl cellulose film, “TD80U” {produced by Fuji Photo Film Co., Ltd.}, in a roll form was unrolled as the support (substrate), and Coating Solution (HCL-9) for Antiglare Hardcoat Layer, where surface-modified low refractive index fine particles was added, was coated directly thereon by using a doctor blade and a 50 mm-diameter microgravure roll having a gravure pattern with a line number of 135 lines/inch and a depth of 60 μm, under the condition of a transportation speed of 15 m/min and after drying at 60° C. for 150 seconds, irradiated with an ultraviolet ray at an illumination intensity of 400 mW/cm² and an irradiation dose of 250 mJ/cm² by using an air-cooled metal halide lamp of 160 W/cm (manufactured by Eye Graphics Co., Ltd.) while purging the system with nitrogen to keep an oxygen concentration of 1.0 vol % or less, thereby curing the coated layer and forming an anti-glare hardcoat layer (HC-9). The resulting film was taken up. After the curing, the rotation number of the gravure roll was adjusted so that the antiglare hardcoat layer could have an average thickness of 8.0 μm.

### Comparative Example 4-1

In the preparation of the antiglare hardcoat film of Example 4-1, Coating Solution (HCL-10) for Antiglare Hardcoat Layer was used in place of Coating Solution (HCL-9) for Antiglare Hardcoat Layer to form Antiglare Hardcoat Layer (HC-10), and the resulting film was taking up.

TABLE 2

| | | | Refractive | | |
|---|---|---|---|---|---|
| | | | Index | Solvent | Solvent |
| | | | of Low | Having SP | Having SP |
| | | Hardcoat | Refractive | value of | Value of |
| | Sample | Coating | Index Fine | 9.5 or | 10.0 |
| | No. | Solution | Particle | More | or More |
| Example 1-1 | 101 | HCL-1 | 1.30 | 36% | 33% |
| Comparative | 102 | HCL-2 | 1.30 | 36% | 33% |
| Example 1-1 | | | | | |
| Example 1-2 | 103 | HCL-3 | 1.30 | 36% | 33% |
| Example 1-3 | 104 | HCL-4 | 1.30 | 5.3% | 0% |
| Example 2-1 | 105 | HCL-5 | 1.30 | 11% | 0% |
| Comparative | 106 | HCL-6 | 1.30 | 11% | 0% |
| Example 2-1 | | | | | |
| Example 3-1 | 107 | HCL-7 | 1.30 | 11% | 0% |
| Comparative | 108 | HCL-8 | 1.30 | 11% | 0% |
| Example 3-1 | | | | | |
| Example 4-1 | 109 | HCL-9 | 1.30 | 10% | 0% |
| Comparative | 110 | HCL-10 | 1.30 | 10% | 0% |
| Example 4-1 | | | | | |

[Measurement of Surface Free Energy]
(1) Surface Energy of Low Refractive Index Fine Particle

The solvent of Silica Liquid Dispersion A or B was removed under pressure by an evaporator to obtain a silica fine particle powder. The obtained silica fine particle powder was formed into a silica fine particle tablet by using a tablet-forming device/tablet-forming press (manufactured by JASCO Corporation). The contact angles of the obtained tablet with water and methylene iodide were measured by using a contact-angle meter (10927, manufactured by Kyowa Interface Science Co., Ltd.). The results obtained are shown in Table 3.

(2) Surface Energy of Binder

Coating Solution (HCL-11) for Hardcoat Layer shown below was prepared as the coating solution for the formation of a binder layer of Coating Solutions (HCL-1) to (HCL-4) for Hardcoat Layer.

Coating Solution (HCL-12) for Hardcoat Layer shown below was prepared as the coating solution for the formation of a binder layer of Coating Solutions (HCL-5) and (HCL-8) for Hardcoat Layer.

Coating Solution (HCL-13) for Hardcoat Layer shown below was prepared as the coating solution for the formation of a binder layer of Coating Solutions (HCL-9) and (HCL-10) for Hardcoat Layer.

[Preparation of Coating Solution for Hardcoat Layer]
{Composition of Coating Solution (HCL-11) for Hardcoat Layer}

| | | |
|---|---|---|
| UV-Curable resin: “DPHA” {produced by Nippon Kayaku | 450.0 | parts |
| Co., Ltd.} | | |
| Isopropyl alcohol | 480.0 | parts |
| Methyl ethyl ketone | 280.0 | parts |
| Cyclohexanone | 39.0 | parts |
| Photoradical polymerization initiator: “Irgacure 907” | 12.0 | parts |
| [produced by Ciba Specialty Chemicals] | | |

{Composition of Coating Solution (HCL-12) for Hardcoat Layer}

| | | |
|---|---|---|
| UV-Curable resin: “PETA” {produced by Nippon Kayaku | 600.0 | parts |
| Co., Ltd.} | | |
| “Irgacure 184” | 20.0 | parts |
| Toluene | 392.0 | parts |
| Cyclohexanone | 137.0 | parts |

{Composition of Coating Solution (HCL-13) for Hardcoat Layer}

| | | |
|---|---|---|
| Zirconia fine particle-containing hardcoat composition | 612.0 | parts |
| solution: “Desolite Z7404” {particle diameter: 20 nm, | | |
| produced by JSR CORP.} | | |
| UV-Curable resin: “DPHA” {produced by Nippon Kayaku | 234.0 | parts |
| Co., Ltd.} | | |
| Methyl ethyl ketone (MEK) | 174.0 | parts |
| Cyclohexanone | 117.0 | parts |

Coating Solutions (HCL-11) to (HCL-13) for Hardcoat Layer each was coated on a Triacetyl cellulose film, “TD80U” [produced by Fuji Photo Film Co., Ltd.], by a bar coater to give a dry thickness of 2 μm and after drying at 60° C. for 150 seconds, irradiated with an ultraviolet ray at an illumination intensity of 400 mW/cm² and an irradiation dose of 250 mJ/cm² by using an air-cooled metal halide lamp of 160 W/cm (manufactured by Eye Graphics Co., Ltd.) while purging the system with nitrogen to keep an oxygen concentration of 1.0 vol % or less, thereby curing the coated layer and forming Hardcoat Layer (HC-11), (HC-12) or (HC-13). The contact angles of the obtained hardcoat layer with water and methylene iodide were measured by using a contact-angle meter (10927, manufactured by Kyowa Interface Science Co., Ltd.). The results obtained are shown in Table 3.

TABLE 3

| | Contact | Contact | Surface | |
|---|---|---|---|---|
| | Angle | Angle | Energy Free | |
| Sample | (H₂O) | (CH₂I₂) | (dynes/cm) | Remarks |
| Silica Liquid | 93.5° | 41.5° | 38.9 | |
| Dispersion A | | | | |
| Silica Liquid | 56.3° | 32.5° | 52.2 | |
| Dispersion B | | | | |
| HC-11 | 69.7° | 42.5° | 42.9 | corresponding to HC-1 |
| | | | | to HC-4 |
| HC-12 | 65.3° | 39.5° | 45.8 | corresponding to HC-5 |
| | | | | to HC-6 |
| HC-13 | 67.8° | 43.6° | 43.3 | corresponding to HC-7 |
| | | | | to HC-8 |

As seen from the results above, by virtue of surface modification with a fluorine-containing silane coupling agent, the surface free energy of the silica fine particle contained in Silica Liquid Dispersion A is reduced to be lower than the surface free energy on the surface of a cured film formed by curing only the binder resin of the hardcoat layer. It is considered that the reduction in the surface free energy of the silica fine particle is bringing uneven distribution of the silica fine particle to the surface.

[Saponification Treatment of Antireflection Hardcoat Film]

After the preparation of antireflection hardcoat film samples, these antireflection hardcoat film samples were subjected to the following treatment.

An aqueous 1.5 mol/liter sodium hydroxide solution was prepared and kept at 55° C. Furthermore, an aqueous 0.01 mol/liter dilute sulfuric acid solution was prepared and kept at 35° C. The produced antireflection hardcoat film was dipped in the aqueous sodium hydroxide solution for 2 minutes and then dipped in water to thoroughly wash out the aqueous sodium hydroxide solution. Subsequently, the sample was dipped in the aqueous dilute sulfuric acid solution for 1 minute and then dipped in water to thoroughly wash out the aqueous dilute sulfuric acid solution. Finally, the sample was thoroughly dried at 120° C.

[Evaluation of Antireflection Hardcoat Film]

(1) Average Reflectance

The spectral reflectance of each antireflection hardcoat film sample at an incident angle of 5° in the wavelength region of 380 to 780 nm was measured by using a spectrophotometer (manufactured by JASCO Corp.). The average reflectance at 450 to 650 nm was used for the result.

(2) Evaluation of Steel Wool (SW) Rubbing Resistance

A rubbing test of each antireflection hardcoat film sample was performed by using a rubbing tester under the following conditions.

Conditions of evaluation environment: 25° C. and 60% RH

Rubbing Material:

A steel wool {“Grade No. 0000”, manufactured by Nippon Steel Wool K.K.} was wound around the tester at the rubbing tip (1 cm×1 cm) coming into contact with the sample and fixed by a band not to move.

Moving distance (one way): 13 cm

Rubbing rate: 13 cm/sec

Load: 1.96N/cm²

Contact area of tip: 1 cm×1 cm

Number of rubbings: 10 reciprocations

An oily black ink was applied to the back side of the rubbed sample, and scratches in the rubbed portion were observed by the reflected light with an eye and evaluated according to the following criteria.

⊚: Scratches were not present at all even when very carefully observed.

◯: Faint scratches were slightly present when very carefully observed.

◯Δ: Faint scratches were observed.

Δ: Scratches of medium degree were observed.

ΔX-X: Scratches were observed at a glance.

(3) Evaluation of Eraser Rubbing Resistance

The antireflection hardcoat film sample was fixed on a glass surface with a pressure-sensitive adhesive, and an eraser “MONO” (trade name) {produced by Tombo Pencil Co., Ltd.} cut out into a diameter of 8 mm and a thickness of 4 mm and used as the rubbing tester head was pressed vertically on the antireflection hardcoat film sample surface from above under a load of 500 g/cm² and moved back and force 200 times with a stroke length of 3.5 cm at a rubbing rate of 1.8 cm/sec under the conditions of 25° C. and 60 RH %. After removing the attached eraser, the rubbed part of the sample was confirmed with an eye. This test was repeated 3 times, and the average degree of surface scratching was evaluated on the following 4-stage scale.

◯: Scratching was scarcely observed.

Δ: Scratching was slightly observed.

X: Scratching was clearly observed.

XX: Scratching was observed over the entire rubbed portion.

(4) Pencil Hardness Evaluation

As an index of damage resistance, the pencil hardness evaluation set forth in JIS k 5400 was carried out. After the anti-reflection hardcoat film was conditioned to an atmosphere of 25° C. temperature and 60% relative humidity for 2 hr, the film was evaluated by using pencils for testing having hardnesses of 2H to 5H defined by JIS S 6006 under a load of 4.9N, and according to the following judgment criteria whereby the evaluation value was represented by the highest hardness for which the criterion is OK.

No damage or a single damage occurred for the evaluation with n=5: OK

Three or more damages occured for the evaluation with N=5: NG (5) Measurement of [B/A]×100

This ratio was measured by the method described above.

TABLE 4

| | | | SW | Eraser | Pencil | |
|---|---|---|---|---|---|---|
| | Sample | Reflectance | Rubbing | Rubbing | hardness | |
| | No. | (%) | Resistance | Durability | evaluation | [B/A] × 100 |
| Example 1-1 | 101 | 1.2 | ⊚ | ◯ | 3H | 500% or more |
| Comparative | 102 | 3.8 | X | X | 3H | 100% |
| Example 1-1 | | | | | | |
| Example 1-2 | 103 | 1.2 | ◯ | ◯ | 3H | 500% or more |
| Example 1-3 | 104 | 1.9 | ◯ | ◯ | 3H | 300% |
| Example 2-1 | 105 | 1.9 | ◯ | ◯ | 3H | 300% |
| Comparative | 106 | 2.2 | X | X | 3H | 100% |
| Example 2-1 | | | | | | |
| Example 3-1 | 107 | 1.5 | ⊚ | ◯ | 5H | 500% or more |
| Comparative | 108 | 2.4 | X | X | 5H | 100% |
| Example 3-1 | | | | | | |
| Example 4-1 | 109 | 1.6 | ◯ | ◯ | 3H | 300% |
| Comparative | 110 | 2.0 | X | X | 3H | 100% |
| Example 4-1 | | | | | | |

The results in Table 4 reveal the followings.

In the case of the antireflection film of the present invention using the surface-modified low refractive index fine particle, an antireflection hardcoat film with low reflectance and excellent scratch resistance can be obtained by one-time coating of the curable composition.

Particularly, with respect to the antiglare hardcoat films of Examples 2-1, 3-1 and 4-1, reduction in the surface reflectance and impartation of surface scratch resistance can be attained by using the curable composition of the present invention.

According to the antiglare hardcoat film of Examples 3-1, a sample having a high pencil hardness in addition to the above-mentioned properties was obtained.

By virtue of incorporating an organic solvent having an SP value of 10.0 or more into the curable composition for the hardcoat layer formation, the low refractive index fine particle can be more concentrated at the surface and the antireflection property and scratch resistance can be more enhanced.

The cross-section of each of Samples 101 to 110 was photographed at a magnification of 150,000 by using a transmission electron microscope, as a result, in the samples of Examples, uneven distribution of hollow particles having a cavity in the inside, which are the low refractive index fine particle, to the surface of the hardcoat layer could be observed. The degree of uneven distribution to surface is shown by the value of [B/A]×100 in Table 4.

The zirconia particle and the silica particle having no cavity in the inside, which were incorporated for the purpose of achieving elevated refractive index, prevented crosslinking shrinkage and increased strength of the hardcoat layer, were found to be uniformly dispersed in the hardcoat layer.

<Production of Polarizing Plate>

### Examples 11-1 to 11-3

A 80 μm-thick triacetyl cellulose film (TAC-TD80U, produced by Fuji Photo Film Co., Ltd.) which had been dipped in an aqueous 1.5 mol/liter NaOH solution at 55° C. for 2 minutes and after neutralization, washed with water was bonded for protection to both surfaces of a polarizer produced by adsorbing iodine to polyvinyl alcohol and stretching the film. The thus-produced polarizing plate was laminated with each of Antireflection Hardcoat Film Samples 103 to 105 of Examples 1-2 to 1-3 and 2-1 of the present invention to produce a polarizing plate with an antireflection film. Using each of the obtained polarizing plates, a liquid crystal display device was produced by disposing the antireflection layer as the outermost surface layer, as a result, low reflectance, less reflection of outside light, indistinctive reflected image and excellent visibility were confirmed.

### Example 21-1

A 80 μm-thick triacetyl cellulose film, “TAC-TD80U” {produced by Fuji Photo Film Co., Ltd.} which had been dipped in an aqueous NaOH solution with a concentration of 1.5 mouliter at 55° C. for 2 minutes and after neutralization, washed with water, and Antireflection Hardcoat Film Sample 103 of Example 1-2 were bonded for protection to both surfaces of a polarizing film produced by adsorbing iodine to polyvinyl alcohol and stretching the film. In this way, a polarizing plate was produced. The thus-produced polarizing plate was laminated to replace the polarizing plate on the viewing side of a liquid crystal display device {where “D-BEF” produced by Sumitomo 3M Ltd., which is a polarizing separation film with a polarization selective layer, is provided between the backlight and the liquid crystal cell} of a note-type personal computer having mounted thereon a transmissive TN liquid crystal display device, such that the antireflection film side became the outermost surface. As a result, a display device with low reflectance, extremely reduced projection of surrounding scene, very high display quality and excellent antifouling property was obtained.

<Liquid Crystal Display Device>

### Examples 31-1 to 31-3

In a transmissive TN liquid crystal cell laminated with each of Antireflection Hardcoat Film Samples 103 to 105 of the present invention, a viewing angle-enlarging film, “Wide View Film SA 12B” {produced by Fuji Photo Film Co., Ltd.}, was used as the protective film on the liquid crystal cell side of the polarizing plate on the viewing side and the protective film on the liquid crystal cell side of the polarizing plate on the backlight side, as a result, a liquid crystal display device with a very wide viewing angle in the up/down and light/left directions, remarkably excellent visibility and high display quality was obtained.

The optical film, particularly, the antireflection hardcoat film, of the present invention is assured of high antireflection property, suitability for mass production and excellent scratch resistance.

Also, a polarizing plate using the optical film of the present invention for a surface protective film is excellent in the optical performance and physical strength and can be massively provided at a low cost.

Furthermore, the image display device of the present invention comprising the above-described optical film or polarizing plate is excellent in the antireflection property, scratch resistance and visibility.

The entire disclosure of each and every foreign patent application from which the benefit of foreign priority has been claimed in the present application is incorporated herein by reference, as if fully set forth.

What is claimed is:

1. An optical film comprising:
a transparent plastic film substrate; and
a cured layer having a dry thickness of 100 nm or more, formed by coating a curable composition comprising: a low refractive index fine particle having a refractive index of 1.50 or less; and a binder resin,
wherein the low refractive index fine particle is unevenly distributed in the cured layer to a surface portion on the side opposite the transparent plastic film substrate.

2. The optical film as claimed in claim 1,
wherein a ratio [(B/A)×100] of: an average filling fraction (B) of the low refractive index fine particle in an region in the cured layer, the region being from its upper side surface opposite the transparent plastic film substrate to a deep portion of 100 nm in a film thickness direction; to an average filling fraction (A) of the low refractive index fine particle in the entire cured layer is 150% or more.

3. The optical film as claimed in claim 1,
wherein the cured layer is formed by: coating the curable composition; causing the low refractive index fine particle to rise toward a surface of the cured layer to be formed, until curing; and curing the curable composition.

4. The optical film as claimed in claim 1,
wherein a surface of the low refractive index fine particle is chemically modified to decrease its surface free energy.

5. The optical film as claimed in claim 4,
wherein a surface of the low refractive index fine particle is chemically surface-modified to have a surface free energy lower than that on a surface of a cured film formed by curing only the binder resin.

6. The optical film as claimed in claim 1,
wherein the curable composition further comprises 5 mass % or more of an organic solvent having a solubility parameter (SP value) of 9.5 or more.

7. The optical film as claimed in claim 1,
wherein the low refractive index fine particle is a silica fine particle.

8. The optical film as claimed in claim 1,
wherein the low refractive index fine particle is a hollow silica fine particle.

9. The optical film as claimed in claim 1,
wherein an average particle diameter of the low refractive index fine particle is 120 nm or less.

10. The optical film as claimed in claim 1,
wherein when the cured layer surface is rubbed with a #0000 steel wool in 10 reciprocations while applying a load of 1.96N/cm², a rubbing mark is not observed with an eye.

11. The optical film as claimed in claim 1,
wherein the average film thickness of the cured layer is from 1.0 to 40 μm.

12. A polarizing plate comprising:
a polarizing film; and
two protective films located on both sides of the polarizing film,
wherein at least one of the two protective films is the optical film claimed in claim 1.

13. A polarizing plate comprising:
a polarizing film; and
two protective films located on both sides of the polarizing film,
wherein one of the two protective films is the optical film claimed in claim 1, and
the other one of the two protective films is an optical compensation film having optical anisotropy.

14. An image display device comprising the optical film claimed in claim 1 disposed on an image display surface of the image display device.

15. An image display device comprising the polarizing plate claimed in claim 12 disposed on an image display surface of the image display device.

16. An image display device comprising the polarizing plate claimed in claim 13 disposed on an image display surface of the image display device.

17. The image display device as claimed in claim 14,
wherein the image display device is a transmissive, reflective or transflective liquid crystal display device in any one mode of TN, STN, IPS, VA and OCB.

18. The image display device as claimed in claim 15,
wherein the image display device is a transmissive, reflective or transflective liquid crystal display device in any one mode of TN, STN, IPS, VA and OCB.

19. The image display device as claimed in claim 16,
wherein the image display device is a transmissive, reflective or transflective liquid crystal display device in any one mode of TN, STN, IPS, VA and OCB.
